(19) United States
(12) Patent Application Publication
(10) Pub. No.: US 2025/0257482 A1
(43) Pub. Date: Aug. 14, 2025

(54) RENEWABLE ENERGY SOURCE USING PRESSURE DRIVEN FILTRATION PROCESSES AND SYSTEMS

(71) Applicant: IDE WATER TECHNOLOGIES, LTD., Kadima (IL)

(72) Inventors: Boris LIBERMAN, Kadima (IL); Tomer EFRAT, Kadima (IL)

(21) Appl. No.: 19/098,901

(22) Filed: Apr. 2, 2025

Related U.S. Application Data
(63) Continuation-in-part of application No. PCT/IB2024/058000, filed on Aug. 17, 2024.
(63) Continuation-in-part of application No. 18/497,768, filed on Oct. 30, 2023.
Application No. 18/497,768 is a continuation-in-part of application No. 18/558,023, filed on Oct. 30, 2023.
(60) Provisional application No. 63/533,495, filed on Aug. 18, 2023.
(60) Provisional application No. 63/618,251, filed on Jan. 5, 2024.
(60) Provisional application No. 63/618,253, filed on Jan. 5, 2024.
(60) Provisional application No. 18/497,768, filed on Oct. 30, 2023.
(60) Provisional application No. 63/533,495, filed on Aug. 18, 2023.

(30) Foreign Application Priority Data
Dec. 29, 2021 (GB) 2119106.9
Dec. 29, 2021 (IL) 289506
May 13, 2022 (GB) 2206994.2
May 13, 2022 (IL) 293000
Dec. 25, 2022 (IL) 299462

(51) Int. Cl. C25B 11/052; C02F 1/44; C02F 103/08; C23C 18/12; C25B 9/23; C25B 11/063; C25B 11/077; C25B 13/02; C25B 15/08

(52) U.S. Cl. CPC C25B 11/052; C02F 1/441; C02F 1/442; C02F 1/444; C02F 1/445; C23C 18/1216; C23C 18/1241; C23C 18/1291; C25B 9/23; C25B 11/063; C25B 11/077; C25B 13/02; C25B 15/08; C02F 2103/08

(57) ABSTRACT

Some embodiments relates generally to the production of a desalinated, filtrated or other way treated water simultaneously with generation of renewal energy source, in particular hydrogen, using osmotic and/or gauge pressure driven filtration processes and systems. The co-generation of hydrogen 11 from water 8 produced during pressure driven water desalination/filtration processes, such as reverse osmosis, forward osmosis, pressure retarded osmosis or ultrafiltration. A small part of feed, raw saline solution and/or permeate involved in a desalination/filtration processes is subjected to electrolysis thereby splitting the water to produce hydrogen. This is achieved by the provision of novel RO type semi-permeable membranes and UF type membrane that incorporate electrodes 9, 10 within the membrane to allow splitting of the water via electrolysis.

### CROSS-REFERENCES TO RELATED APPLICATIONS

The present application is a continuation-in-part of International Application No. PCT/IB2024/058000, filed on Aug. 17, 2024, which claims priority to U.S. Patent Application No. 63/533,495 filed on Aug. 18, 2023; U.S. Patent Application No. 63/618,251 filed on Jan. 5, 2024; and U.S. Patent Application No. 63/618,253 filed on Jan. 5, 2024.

The present application is a continuation-in-part of U.S. patent application Ser. No. 18/497,768 filed on Oct. 30, 2023, which is a continuation-in-part of U.S. patent application Ser. No. 18/558,023 filed on Oct. 30, 2023, which is a National Stage Entry of PCT/IB2022/062890 filed on Dec. 29, 2022, and claims priority to U.S. Patent Application No. 63/533,495 filed on Aug. 18, 2023, and claims priority to United Kingdom application no. 2119106.9 filed on Dec. 29, 2021, and claims priority to Israeli application no. 289506 filed on Dec. 29, 2012, and claims priority to Israeli application no. 299462 filed on Dec. 25, 2022, and claims priority to Israeli application no. 293000 filed on May 13, 2022, and claims priority to United Kingdom application no. 2206994.2 filed on May 13, 2022, the contents of each of which are hereby incorporated in their entireties by reference.

### FIELD OF THE DISCLOSURE

The presently disclosed subject matter relates generally to the production of a renewal energy source, in particular hydrogen, using pressure driven filtration processes and systems. The presently disclosed subject matter relates generally to the production of a desalinated, filtrated or other way treated water simultaneously with generation of renewal energy source, in particular hydrogen, using osmotic and/or gauge pressure driven filtration processes and systems

### BACKGROUND

The development of renewal energy sources is becoming increasingly important to address global warming and other environmental issues. Hydrogen is a good energy carrier for energy storage and hydrogen burns to produce water, with zero CO₂ emissions. Thus, the efficient production and storage of hydrogen for energy generation is a very attractive proposition.

Water electrolysis technologies are known for producing hydrogen from water. Water is the reactant, which is dissociated to hydrogen and oxygen using a direct current.

H₂0 [symbol] ½0₂+2H⁺+2e⁻ Anode:

2H⁺+2e⁻ [symbol] H₂ Cathode:

H₂0 [symbol] H₂+½0₂ Overall:

A number of different types of water electrolysis processes have been investigated for hydrogen production including alkaline water electrolysis, proton exchange membrane water electrolysis, solid oxide water electrolysis and alkaline anion exchange membrane water electrolysis.

The satisfactory scale up of hydrogen generation may be hindered by a lack of a suitable source of water, a renewable energy source and/or a convenient location for storage of the hydrogen produced.

It is the aim of the presently disclosed subject matter to provide an improved devices, processes and systems for hydrogen generation that address some or all of these issues.

### SUMMARY OF THE DISCLOSURE

According to a first aspect of the presently disclosed subject matter there is provided a membrane element configured for osmotic and/or gauge pressure driven filtration of water and electrochemical splitting of at least a proportion of the water for the co-generation of hydrogen, the membrane element comprising at least one selectively permeable membrane configured to least partially purify feed water when a pressure difference is provided across the membrane, wherein the membrane element includes at least one anode electrode and at least one cathode electrode.

In the context of this disclosure, the selectively permeable membrane is any type of reverse osmosis (RO) or ultrafiltration (UF) type membrane that may be used for osmotic and/or gauge pressure driven filtration of water. “RO” type of membrane includes those membranes used for reverse osmosis, pressure retarded osmosis (PRO), forward osmosis (FO) and nanofiltration (NF). “UF” type of membrane includes those membranes used for ultrafiltration (UF), microfiltration (MF) and other purification from suspended solids processes. These types of membranes are selectively permeable with a maximum pore size of 0.1 microns. In this respect, the type of membrane will have a particular pore size, for example MF membranes generally have a maximum pore size of about 0.1 microns; UF membranes generally have a pore size of 0.01 to 0.1 microns; NF membranes generally have a maximum pore size of 0.01 microns and RO membranes generally have a pore size of 0.0001 microns. However, other parameters may be used to characterize these types of membranes as is known in the art.

The membrane element of the first aspect is preferably incorporated into a module configured for pressure driven filtration of water and electrochemical splitting of at least a proportion of the water for the co-generation of hydrogen. To this end, a second aspect of the presently disclosed subject matter provides a module comprising:
a feed water inlet;
at least one membrane element according to the first aspect of the presently disclosed subject matter; and
a product water outlet and optionally a reject water outlet.

The optional reject water outlet is for the reject flow which is the part of feed water which does not pass the membrane, being rejected as brine in selectively permeable membrane application. This reject flow may not exist in UF and MF applications.

Additionally, the module may be provided with a hydrogen and/or oxygen outlet. However, more preferably, dissolved hydrogen and/or free gas hydrogen is provided in the reject flow or product water for later extraction therefrom, for example by degasification or gas separation membranes.

The membrane element according to the first aspect of the presently disclosed subject matter and the module according to the second aspect of the presently disclosed subject matter may be incorporated into any pressure driven water filtration process or system to provide simultaneous co-generation of at least partially purified water and hydrogen.

Accordingly, a third aspect of the presently disclosed subject matter provides a process for pressure driven water filtration with co-generation of hydrogen, the process comprising:
supplying feed water from a feed water inlet to a membrane element according to the first aspect of the presently disclosed subject matter;
applying a pressure differential across the RO and UF type selectively permeable membrane of the membrane element to draw feed water through the membrane to form a product water;
applying a potential difference between the electrodes of the membrane element to cause electrochemical splitting of at least a portion of the feed and/or product water for formation of hydrogen and oxygen; and collecting the product water and optionally a reject flow, and hydrogen.

Preferably, the hydrogen is dissolved in at least one of the product water or reject flow for subsequent extraction therefrom, for example by degasification or membrane gas separation. Alternatively, the hydrogen could be in a free gas form.

A fourth aspect of the presently disclosed subject matter provides a system for pressure-driven water filtration with the co-generation of hydrogen, the system comprising:
a feed water inlet;
at least one membrane element according to the first aspect of the presently disclosed subject matter;
at least one pump to apply a pressure to the feed water;
a power source to provide a potential difference to the electrodes of the membrane element;
a product outlet and optionally a reject water outlet; and
a hydrogen outlet within the product and/or reject water.

In embodiments, the membrane element and module of the first and second aspects of the presently disclosed subject matter respectively may form part of a pressure retarded osmosis (PRO) system to provide electricity from the water with the co-generation of hydrogen. However, more preferably, the membrane element or module is incorporated into a reverse osmosis (RO) or Nano Filtration (NF) or other brand name system for the desalination of water and co-generation of hydrogen.

Alternatively, the element or module may be incorporated into any other water filtration system, such as ultrafiltration or microfiltration systems, to provide purified water and hydrogen generation, all of which are discussed further herein. The main difference between RO; PRO; NF from UF and MF is that RO; PRO; NF implement salt rejection semipermeable membrane and have a reject flow. The UF and MF membrane are not salt rejection semipermeable and do not have reject flow. However, all may be provided with electrodes within or on their membranes to allow water splitting in accordance with the presently disclosed subject matter.

In the context of this disclosure, reverse osmotic (RO) separation processes where semipermeable salt rejection layer is included in the membrane extends to Reverse Osmosis (RO); Nano Filtration (NF) and any other salt rejection semipermeable membranes in which RO dissolved ion separation process take place. Pressure Retarded Osmosis (PRO) processes where semipermeable salt rejection layer is included in the membrane applies to any processes where the semipermeable membrane may act as an osmotic pump and low salinity water penetrates into high salinity water. This is a different physical process than RO dissolved ion separation process and also applies to Forward Osmosis (FO), and any other processes wherein the membrane acts as osmotic pump

Water filtration processes and systems of the presently disclosed subject matter include Ultra Filtration (UF) and Micro Filtration (MF) and other processes based on non-salt rejection semipermeable membranes in which water is moving through any membrane driven by gauge pressure for purpose of water treatment (purification from suspended solids), and hydrogen generation is a complementary co-generation activity. In presently disclosed subject matter membrane implemented for UF, MF and other purification from suspended solids processes will be mentioned in one general name “UF type membrane”

The particular number and arrangement of inlets and outlets provided within an embodiment of a module, process or system of the presently disclosed subject matter is dependent upon the type of desalination or water treatment process in relation to which the electrochemical splitting of water is incorporated. For RO; NF processes, the module has one inlet “Raw saline solution” and two outlets: “residual brine stream” (“reject flow” or “reject outlet”) and a “Permeate stream”. Hydrogen can go out from one or both of these outlets.

The module for a PRO process has two inlets and two outlets. An inlet for “Draw Solution” and for “Feed water” and two outlets, an outlet for “Residual fluid stream” and an outlet for “Residual brine”. Hydrogen may go out from one or both of these outlets.

In contrast, for UF and MF processes, the module usually has one inlet “Feed Water” and one outlet “Filtrated Water”. Hydrogen can go out from only one outlet.

In all of the aforementioned systems and processes, only a small proportion of the water involved in RO; NF; PRO; UF; MF is subject to electrochemical splitting to form hydrogen within the membrane, with the remainder producing the product or filtrated water or the rejected draw solution. Preferably, less than 5% of the above mentioned water is split. More preferably, for all processes the amount is less than 1%; especially 0.05%, or more especially 0.01% or ideally less than 0.01%.

The membranes, modules, systems and processes according to the presently disclosed subject matter should be provided with an appropriate power source to enable a current to be applied across the electrodes to enable electrochemical splitting of the water to occur. Preferably low current densities are used, preferably below 100 mA/cm², more preferably below 10 mA/cm²; especially below 5 mA/cm², ideally below 1 mA/cm².

The process may also provide for pH correction to optimize the reaction taking place across the electrodes, for example to decrease the reversible potential of oxygen evolution reaction.

It is to be appreciated that any type of RO and UF type membrane may be provided within the module for carrying out osmotic and/or gauge pressure-driven filtration of the feed water. However, the membrane is adapted to include an anode and cathode and as an option an additional electrode to allow for electrochemical split of part of the penetrated water to generate hydrogen. Suitable membranes incorporating these electrodes may be provided in a very wide range of configurations and are not limited to the specific permutations disclosed herein.

For example, in one embodiment, the module comprises at least one RO type membrane comprising a salt rejection layer and a support layer, the membrane including at least one anode electrode and at least one cathode electrode, the electrodes comprising the salt rejection layer and/or being provided in, on or between one or both the salt rejection and support layers.

In embodiments, the membrane element or module may incorporate feed and/or permeate spacers. The electrodes may be provided on or adjacent one or other of the feed and/or permeate spacers.

The salt rejection layer, support layer, feed or permeate spacers serve to act as mechanical supports for the electrodes. Thus, the existing permeate and feed spacers of RO, PRO; NF, and FO modules, as well as semipermeable layers of RO; PRO; NF, and FO membranes can be used as is for separation of the anode and cathode electrodes incorporated into the membrane elements of the presently disclosed subject matter.

In UF type membrane the cathode and anodes may be positioned on either one or both inside and/or outside of these hollow-fibres membranes.

The electrodes may be incorporated into the RO type membrane in many different configurations. For example, the at least two electrodes may be provided between the salt rejection and the support layers. Alternatively, at least one electrode may be positioned between the salt rejection layer and the support layer and at least one electrode may be provided on an external surface of the salt rejection layer. In another embodiment, the at least two electrodes may both be provided on an external surface of the salt rejection layer.

In yet another embodiment the electrodes may be located on permeate and/or feed spacers, more preferably the electrodes are positioned on either side of the permeate or feed spacer. In alternative embodiments, both electrodes may be located on one side of permeate and/or feed spacers. In other embodiments, one electrode may be located on one side of permeate and/or feed spacers and the other electrodes may be located on opposite site of permeate and/or feed spacers.

In alternative embodiments of the presently disclosed subject matter, the electrode (anode and/or cathode) may be coupled to the permeate or the feed spacer. Preferably, the feed spacer is mechanically coupled to the permeate tube. In one embodiment, the anode may be coupled to the feed spacer and the cathode may be coupled to the permeate spacer. In an alternative embodiment, the cathode may be coupled to the feed spacer and the anode may be coupled to the permeate spacer. In yet other embodiments, the polarity of the spacers may be alterable so as to control which electrode is utilized as the cathode and which as the anode.

In other embodiments, the electrode (anode and/or cathode) may comprise the feed and/or permeate spacer. In such embodiments, the spacer is at least partially coated with an electrically conductive layer and/or a catalytic layer, thereby making the electrode electrically conductive and electrocatalytically active as anodes (for O₂ evolution) or electrocatalytically active as cathodes (for H₂ evolution) or both. The spacers may be at least partially coated with at least one catalyst, for example being selected from Pt, Ir and any combination thereof.

The conductivity of the spacers may be obtained via, for example, coating of the polymer spacer with a nickel or copper metal and then displacing these metals with a Pt- or Ir-group catalyst, for example by redox displacement or other techniques.

In embodiments, the electrodes may be provided in the form of a grid or parallel spaced apart strips. Alternatively, the electrodes may be provided in the form of a full or partial coating of the permeate and/or feed spacer.

Furthermore, the salt rejection layer or spacers may be formed of a material that may allow them to serve as one of the electrodes, i.e., of a material having sufficient conductivity (such as e.g., graphite, composite of polymer and conductive particles, or metals).

More preferably still, the at least one electrode may be formed from graphene. In one embodiment, the electrode (anode and/or cathode) is graphene or carbon fiber/carbon cloth.

Preferably, the carbons are substrates for coating with mixed metal oxides (MMO) selected from platinum (Pt), iridium (Ir), Pt-Ir, ruthenium (Ru) metals, Cobalt, Nickel, and any combinations thereof. In these embodiments, the MMO/C electrodes may be prepared by a two-step process comprising forming a sacrificial copper or nickel layer on the carbon via electroless or electrodeposition and displacing the sacrificial metal by Pt, Ir, Ru or Pt—Ir.

In embodiments, the salt rejection layer may be formed from graphene and comprise one of the electrodes. The support layer is preferably comprised of a porous material, preferably being a ceramic material.

Alternatively, the electrode (anode and/or cathode) may be a titanium material to enhance durability.

The electrode may be provided in any configuration but is preferably selected from the group consisting of a mesh, plate, foil, cloth formed of fiber and a sintered body, more preferably being made of titanium.

The semi-permeable membrane may further comprise a reference electrode. Optionally, at least one dielectric material may be provided between the at least two electrodes. The feed and/or permeate spacers may act as a dielectric material for the electrodes printed, coated or located on each side of the spacer(s).

Additionally, at least one catalyst may be provided on at least one or both of the electrodes to enhance the desired reaction, for example to facilitate oxygen and hydrogen generation and hamper chlorine evolution.

In one embodiment, the electrode may be at least partially coated with at least one catalyst. Preferably, the catalyst is selected from at least one of the group consisting of iridium oxide, ruthenium oxide, tantalum oxide, titanium oxide, platinum, and platinum oxide, Cobalt, Cobalt oxide, Nickel, Nickel oxide and any combination thereof.

As mentioned above, the process and system according to the third and fourth aspects of the presently disclosed subject matter may be applied to many different types of pressure driven water filtration processes and systems.

In a preferred embodiment, the process and system comprise a reverse osmosis (RO) process and system for splitting water to hydrogen and oxygen in an osmosis separation module comprising at least one, preferably multiple membrane elements, said membrane having a feed side and permeate side with the at least two electrodes positioned on the RO type membrane, and/or support layer, and/or feed and/or permeate spacers of the membrane element. Raw saline solution is delivered to the module and a part of the raw saline solution exits the module as a residual brine stream, part of the raw saline solution penetrating the membrane in a normal reverse osmosis process to produce desalinated water by a net driving force of the balance of the gauge and osmotic pressures and exiting from a permeate side of the membrane element as a permeate stream.

The process includes applying continuously, or for a predetermined period, electrical current to membrane electrodes, which causes part of the raw saline solution and/or permeate stream to be split into hydrogen and oxygen gases for evacuation from the osmosis separation module together with the residual brine stream and/or permeate stream. Thus, the RO module combines desalination of raw saline solution for commercial use with the simultaneous splitting of water into hydrogen and oxygen. Preferably, less then 5% of raw saline solution is used for hydrogen generation, more preferably less than 1%.

Alternatively, the process and system may be applied to a water purification process conducted on non-salt rejection semipermeable membrane such as Ultra Filtration and Microfiltration membrane in UF or MF process. In this embodiment, less than 1% of filtered water is used for hydrogen generation, preferably less then 0.1% of filtered water.

Such a process and system for providing filtration of water and cogeneration of hydrogen may include a suspended solids fouling filtration module, said membrane element having a feed side and filtered side with at least two electrodes positioned on the membrane, and/or the support layer, and/or the feed and/or filtered water spacers, wherein a raw saline solution enters the feed stream side of the module, and at least partially penetrates the membrane in a normal filtration process by a driving force of the gauge pressures and exits from the filtered side as a filtered stream, said method for splitting water to hydrogen and oxygen comprising: applying continuously, or for a predetermined period, electrical current to the electrodes, which cause part of the permeate stream to be split into hydrogen and oxygen gas for evacuation from the filtration module together with the filtered water stream.

In another embodiment, there is provided an osmotic process and system for the splitting of water to hydrogen and oxygen comprising delivering first and second solutions of different osmotic and gauge pressures to opposing sides of a RO type semi-permeable membrane to create a low salinity solution across the membrane; the semi-permeable membrane including at least two electrodes; applying a current across the electrodes of the RO type semi-permeable membrane to split the low salinity solution into hydrogen and oxygen; and collecting the hydrogen and oxygen (both either dissolved and/or free gas).

Generally, the first solution is known as the draw solution and the second solution is known as the feed solution. For example, the feed solution may comprise sea water, brackish water, wastewater or fresh water, such as river or ground water.

The osmotic process may comprise pressure retarded osmosis or forward osmosis wherein the RO type semi-permeable membrane has a first side and a second side opposite the first side; a first saline solution comprising the draw solution having an osmotic pressure POr and a gauge pressure PGr for entering the first side of the membrane; a second saline solution comprising a feed solution having an osmotic pressure POp and a gauge pressure PGp for entering the second side of the membrane; at least part of the feed solution from the second side of the membrane penetrating to the first side according to a net driving pressure defined by the balance of pressures PGr, POr, POp and PGp; wherein the draw solution and the penetrated part of the feed solution exit as a residual brine stream from the first side of the membrane via a residual brine outlet; a remainder of the feed solution at least periodically exits as a residual fluid stream from the second side of the membrane via an outlet and wherein at least part of a low salinity solution stream passes from the second side to the first side for splitting into hydrogen and oxygen as it passes across the semi-permeable membrane.

Additionally, or alternatively, at least part of the first saline solution and/or the second feed solution that passes along membrane goes for splitting into hydrogen and oxygen as it passes along the semi-permeable membrane.

It is to be appreciated that the processes and systems according to the third and fourth aspects of the presently disclosed subject matter may, and preferably do, incorporate conventional steps and components for carrying out these processes and systems that are used in the prior art processes and systems. For example, intake and discharge channels, pre- and post-treatment units; pumps, control valves, delivery pipes and control units.

Preferably, the energy for operation of the process and system is produced efficiently. For example, the electricity for operation of the electrodes of the membrane may be provided using pressure retarded osmosis wherein the draw solution is provided by dissolving rock salt in salt domes. The dissolution of rock salt may be carried out under pressure, equal or near to PGr. Alternatively, dissolution may take place under atmospheric pressure. It is to be appreciated that the salt domes may also be used to store the hydrogen generated by the process.

Alternatively, the generated hydrogen may be stored in holding tanks for later use or fed into a network grid for use.

### BRIEF DESCRIPTION OF THE DRAWINGS

For a better understanding of the presently disclosed subject matter and to show more clearly how it may be carried into effect, reference will now be made by way of example only to the accompanying drawings in which:

FIG. 1A is a schematic diagram illustrating the principle of alkaline water electrolysis according to the prior art;

FIG. 1B is a schematic diagram illustrating the principle of proton exchange membrane (PEM) water electrolysis according to the prior art;

FIG. 2A is a schematic top view of a section through FO or PRO semi-permeable membrane incorporating electrodes according to an embodiment of the presently disclosed subject matter;

FIG. 2B is a three-dimensional view of the semi-permeable membrane shown in FIG. 2A, with the salt rejection layer 4 and feed 7 removed;

FIG. 3 is a three-dimensional view of a semi-permeable membrane incorporating a pair of electrodes according to an alternative embodiment of the presently disclosed subject matter;

FIG. 4 is a three-dimensional view of a semi-permeable membrane incorporating a pair of electrodes according to yet another embodiment of the presently disclosed subject matter;

FIG. 5 is a three-dimensional view of a semi-permeable membrane incorporating a pair of electrodes according to still yet another embodiment of the presently disclosed subject matter;

FIG. 6A is a fragmented three-dimensional view of a semi-permeable membrane having permeate and feed spacers and incorporating electrodes according to yet a further embodiment of the presently disclosed subject matter;

FIG. 6B illustrates two membranes according to FIG. 6A arranged in mirror symmetry;

FIG. 7 is a schematic diagram of a seawater desalination plant and process scheme in which one or more semi-permeable membranes according to the presently disclosed subject matter may be incorporated;

FIG. 8 is a graph of reversible potentials for chlorine evolution, oxygen evolution and hydrogen evolution reactions as a function of pH. T=25° C., [Cl⁻]=20 g/L fugacity of gases=1, no complexation, infinite dilution;

FIG. 9 is schematic diagram illustrating an embodiment of a system of the presently disclosed subject matter for hydrogen generation and storage;

FIG. 10 is a schematic diagram of a permeate tube with a pair of spacers and electrodes coupled thereto according to an embodiment of the presently disclosed subject matter; and

FIG. 11 is a schematic diagram of a permeate tube with multiple spacers and electrodes coupled thereto according to another embodiment of the presently disclosed subject matter.

FIG. 12 is a schematic diagram of a Titanium foil cladding 300 to permeate and/or feed spacers with and without additional electricity conductors between titanium foil and plastic spacer.

FIGS. 13-14 are schematic diagrams providing different examples of corrugation (or embossing) patterns.

FIG. 15 illustrates an embodiment where the electrode (e.g., the Titanium foil) substitutes at least one selected from a group consisting of permeate spacer, feed spacer and any combination thereof.

FIGS. 16-22 are schematic diagrams of coupling between the electrode, which could serve as the spacers (permeate and/or feed spacers) and the permeate tube.

FIGS. 23-25 are schematic diagrams of embodiments utilizing bi-polar electrodes.

FIGS. 26-29 are schematic diagrams of embodiments utilizing another embodiment where at least a portion of the spacers (feed spacers and/or permeate spacers) are joint together.

### DETAILED DESCRIPTION

The presently disclosed subject matter relates generally to the novel generation of hydrogen from water produced during water desalination or water treatment processes that use RO or UF-type membranes, wherein feed water is pressure driven (for example by osmotic and gauge pressures) against the membrane to allow certain components to pass through the membrane while other components are rejected, with a proportion of the water being split electrochemically to produce hydrogen.

In some instances, the process utilises feed water penetrated via RO type semipermeable membrane in to draw solution during pressure retarded osmosis process PRO, or forward osmosis FO. The very low salinity water passes via the RO type semi-permeable membrane from feed stream to draw solution stream. A small portion of this very low salinity water is subjected to electrolysis thereby splitting the water to produce hydrogen. This is achieved by the incorporation of one or electrodes into the RO type semi-permeable membranes conventionally used in these pressure-driven energy generation processes to provide modified membranes that allow simultaneous splitting of the water via electrolysis in addition to the standard PRO conventionally carried out process using these types of membrane.

Pressure retarded osmosis (PRO) is an osmotically driven membrane process that uses energy harnessed from the mixing between high and low salinity streams to produce mechanical energy (utilization of Gibb's free energy of mixing). Water permeates through RO type semi-permeable membranes from a low concentration feed stream into a high concentration, partially pressurized, brine stream (“draw solution”). The hydraulic pressure is less than its osmotic pressure resulting in a net osmotic driving force for transport of water (permeate stream) from the feed stream to the brine stream. The permeate stream becomes pressurised and dilutes the brine stream and the energy in the pressurised permeate stream can be converted into mechanical or electrical energy via a turbine generator.

Forward osmosis is an alternative osmotically driven membrane process that uses the RO type membrane to treat two liquid feed streams. One side of the membrane is a feed solution (FS) with a low osmotic pressure and the other side of the membrane is the draw solution (DS) with a higher osmotic pressure. The difference in osmotic pressure causes water to pass through the membrane from the FS side to the DS side, simultaneously diluting the DS and concentrating the FS. The RO type membranes consist of an active layer (or salt rejection layer) and a porous support layer, with the FS side generally facing the active layer.

Both these processes generate a very low salinity water stream across the membrane. The presently disclosed subject matter utilizes this water stream for the production of hydrogen. However, the presently disclosed subject matter is not limited to these types of membrane and could also be implemented in other types, such as reverse osmosis membranes and nanofiltration membranes. A RO type semipermeable membrane is basically a very thin layer of polymeric material that acts as a barrier layer and separates dissolved ions or molecules from water when the applied pressure is greater than osmotic pressure.

In one embodiment, the presently disclosed subject matter utilizes a permeate stream produced during PRO or FO. This stream cannot be directly measured because it cannot be extracted from the membrane and is extremely thin. However, the inventors have recognized for the first time that this stream may be used for hydrogen production due to its extremely low salinity. In this respect, it is not readily known that at the contact surface between the salt rejection layer and the support layer of FO and/or PRO membranes there is continuous movement of low salinity water which has salinity about 1000 times less than feed solution (seawater) moving on one side (FS) of the FO/PRO membrane and about 10,000 less salinity than the draw solution (DS) on the other side. The present innovation positions electrodes in this extremely thin low salinity stream for the purpose of water split for hydrogen and oxygen production. Thus, the presently disclosed subject matter provides novel permeable membranes for enabling water split and furthermore, provides a novel method and system for generating hydrogen and oxygen from water.

The presently disclosed subject matter may also be incorporated into RO and NF processes wherein a small portion of the raw salinity feed water and/or permeate water is subjected to electrolysis thereby splitting the water to produce hydrogen. This is again achieved by the incorporation of one or electrodes into the RO type semi-permeable membranes conventionally used in these pressure-driven water desalination processes to provide modified membranes that allow simultaneous splitting of the water via electrolysis in addition to the standard water desalination conventionally carried out using RO type of membrane.

Alternatively, the presently disclosed subject matter may be incorporated into UF and MF processes wherein a small portion of the feed water and/or filtrated water is subjected to electrolysis thereby splitting the water to produce hydrogen. This is again achieved by the incorporation of one or electrodes into the UF type of membranes conventionally used in these pressure-driven water treatment processes to provide modified membranes that allow simultaneous splitting of the water via electrolysis in addition to the standard water treatment conventionally carried out using UF types of membrane.

The following explanation applies equally to RO; NF; PRO; UF; MF processes that be modified according to the presently disclosed subject matter to provide hydrogen generation.

The presently disclosed subject matter provides for simultaneous water desalination (RO, NF) or water treatment (UF, MF, FO) or osmotic power generation (PRO) and electrochemical production of hydrogen gas for conversion and storage of electrical energy (hydrogen economy). Electrochemical and membrane reactors have at least two common components: spacers and membranes. Moreover, modern water electrolysis systems utilize ultra-pure water. Electrolysis of deionized water directly in a desalination or filtration module using same membranes, spacers, control and automation units, hydraulic system, and other equipment and materials will reduce drastically operational and capital costs of water electrolysis and will provide an added value to the desalination or water treatment plants.

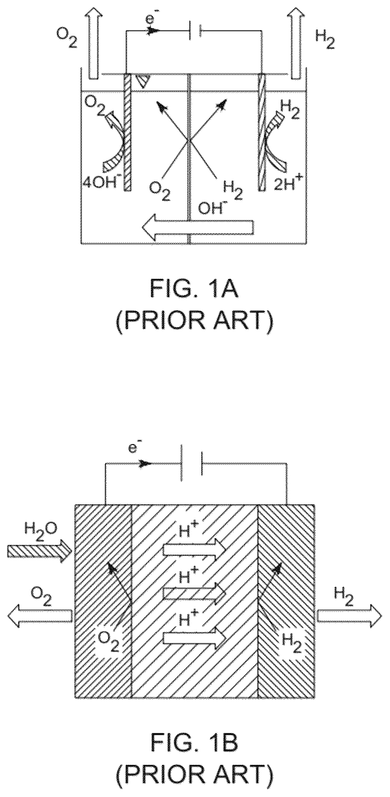

Conventional water electrolysis processes are operated at current densities of 200 to 2000 mA/cm² (and even higher). These high current densities are required to decrease the footprint of reactors and to minimize capital costs of these processes. There are currently three main processes for hydrogen production using water electrolysis (WE): (i) alkaline water electrolysis (see FIG. 1A), (ii) polymer electrolyte membrane (PEM) electrolysis (see FIG. 1B); and (iii) steam or solid oxide electrolysis (SOE). The SOE processes are performed at high temperatures (>500° C.) and are not relevant to the presently disclosed subject matter and thus will not be discussed in any further detail.

All WE techniques are based on oxidation and reduction of water molecules or H+ and OH− ions into oxygen and hydrogen gases on anodes and cathodes. These processes consume electrical energy and heat with the reaction occurring at the anodes and cathodes being dependent upon the pH in the electrolyzed solution, as set out below:

### In Alkaline Solutions (See FIG. 1A):

Anode: 2OH⁻→0.5O₂+H₂O+2e⁻ Er⁰=0.401V vs. SHE (1)

Cathode: 2H₂O+2e⁻→H₂+2OH⁻ Er⁰=−0.828V vs. SHE (2)

### In Acidic Solutions (See FIG. 1B):

Anode: H₂O→0.5O₂+2H+⁺2e⁻ Er⁰=1.229 V vs. SHE (3)

Cathode: 2H⁺+2e⁻→H₂ Er⁰=0.0 V vs. SHE (4)

Overall: H₂O→H₂(g)+0.5O_{2(g)} Vᵣₑᵥ=1.229 V (5)

(where Vᵣₑᵥ is a reversible voltage (Volt), Er⁰ is a standard reduction potential (Volts vs. standard hydrogen electrode, SHE).

The oxidation and reduction processes proceed on the anodes and cathodes, respectively. In all electrolysis cells, the anodes are more positive than the cathodes. The electrons flow from anodes to cathodes (i.e., in the direction opposite to a flow of electric current) through an external wire (or other, normally metallic conductors) connected to a direct current (DC) supply. The electrical circuit of the electrochemical cell requires movement of electrical charges (i.e., ions) in the electrolyzed solution. In other words, an electrolyte must be present in water to sustain the WE process. Two major types of electrolytes are used in low temperature (i.e., T≤100° C.) water electrolysis processes: (1) salts, acids, and bases; and (2) solid electrolytes.

As follows from Eqs (1)-(4) above, anodic and cathodic reactions produce H⁺ and OH− ions in the electrolyzed solution. These ions can be utilized to conduct the ionic current in water electrolysis. In this case no addition of external electrolyte would be required. This principle is utilized in solid electrolyte water electrolysis processes, as shown in FIG. 1B. The “solid electrolyte” term refers to an ion-exchange membrane which is located between anode and cathode in an electrochemical cell. Normally polymeric cation-exchange membranes (e.g., Nafion, the sulphonated tetrafluoroethylene-based fluoropolymer-copolymer) are used in this type of WE devices. For this reason, the term “proton exchange membrane (PEM) water electrolysis” and the abbreviation PEM are used in professional literature. The membrane in its original form contains fixed negatively charged sulfonic groups and exchangeable H+ ions. Anodic production of oxygen via reaction Eq. (3) results in generation of H+ ions. These ions flow through the membrane (ionic current in a “solid” electrolyte) and get consumed within the hydrogen evolution reaction that proceeds on a cathode via reaction Eq. (4). This way the overall concentration of H+ ions in the membrane remains constant. The PEM electrolyzes requires ultra-pure deionized water (less than 0.5 ppm of total dissolved solids to prevent deterioration of membranes) and expensive noble metal catalysts (e.g., IrO₂ for anodes and Pt for cathodes).

These conventional water electrolysis processes require ionic carriers that can be (1) originally present in the electrolyzed water (e.g., seawater), (2) added into deionized water (e.g., alkaline water electrolysis), or (3) provided with the ion-exchange membranes. Electrolysis of pure water is not generally carried out.

Seawater is potentially an endless source of water for electrochemical generation of hydrogen. However, there are two crucial obstacles that must be overcome for the development of industry-scale hydrogen production by seawater electrolysis: (1) scaling of cathodes with Ca and Mg deposits, and (2) production of chlorine species by anodic oxidation of chloride ions.

With regard to the scaling issue, seawater contains significant amounts of magnesium and calcium ions that precipitate in alkaline solutions and/or on a cathode due to the high local pH that exists in the near cathode area because of hydrogen evolution reaction. The pH that develops in the near cathode area at current densities of >100 mA/cm2 can be as high as pH=12. Consequently, the direct seawater electrolysis at current densities ≥200 mA/cm² inevitably results in detrimental deposition of Ca and Mg species on cathodes.

Furthermore, anodic production of chlorine gas also creates a significant problem. In this respect, seawater contains high concentrations of chloride ions that can be oxidized on an anode to produce chlorine gas. This is then hydrolyzed into hypochlorous acid (HOCl) which exists in equilibrium with hypochlorite ions (OCl⁻). At Cl concentrations typical for seawater (ca. 20 g/L) current density for Cl₂ evolution reaction can be as high as >70%. This means that Cl₂ is the primary anodic product if direct seawater electrolysis process is performed using typical water electrolysis anodes (e.g., graphite, Pt, mixed metal oxides, IrO₂, etc.). Production of chlorine in seawater electrolysis aimed at mass production of H₂ must be prevented.

The presently disclosed subject matter reduces or eliminates all these problems by the incorporation of electrodes into the conventional pressure-driven membranes utilized in desalination or water treatment processes. This represents a significant step forward in the generation of hydrogen from accessible water sources.

The processes and systems of the presently disclosed subject matter which perform simultaneously pressure-driven membrane filtration of water with electrochemical splitting of water to produce hydrogen are very different to the prior art large scale electrochemical splitting of water.

The presently disclosed subject matter provides hydrogen production at ≈1 g/m²/h range corresponding to a current density of ≈3 mA/cm² which is extremely low if compared to electric currents applied in the state-of-the-art alkaline and solid electrolyte water electrolysis reactors (200-2000 mA/cm²). However, the integration of electrochemical process into the water desalination or filtration modules according to the presently disclosed subject matter is not expected to result in a larger footprint of desalination or water treatment facilities already in existence. Moreover, operational costs are expected to be even lower than the well-established water electrolysis technologies. This is, for example, because electrolysis of seawater (or RO brine or other water to be purified) at very low current density (1) consumes less energy per unit volume of generated hydrogen gas; (2) does not produce chlorine, which is unwanted in seawater electrolysis aimed at hydrogen gas production; (3) can be performed using cheap catalysts with longer operational lifetime; and (4) will not produce detrimental precipitates of, for example Ca and Mg salts on the cathodes.

Usually desalinated water includes Ca, Mg, Na, CO₃, SO₄, HCO₃, Cl and other ions in an amount 10 to 300 ppm. During water split the concentration of dissolved solids in permeate water stream is increasing. If all permeate is used for split, two problems will arise; (i) scaling formation CaCO₃, CaSO₄ etc and (ii) increased conductivity of permeate which will increase power consumption for hydrogen generation. The combination of two processes (desalination and split), (energy generation and split) or (water filtration and split) in one membrane element solves this contradiction. Furthermore, the presently disclosed subject matter is cost efficient because common water pumping and water filtration equipment is used for the two combined processes.

Any pressure-driven membrane that provides for desalination or filtration of water may be adapted to simultaneously produce hydrogen according to the presently disclosed subject matter, such as RO, NF, PRO, FO, UF and MF membranes. In the context of this disclosure, these are referred to as RO-type or UF-type membranes and generally these consist of semi-permeable membranes with a maximum pore size of 0.1 microns. In this respect, the type of membrane will have a particular pore size, for example MF membranes generally have a maximum pore size of about 0.1 microns; UF membranes generally have a pore size of 0.01 to 0.1 microns; NF membranes generally have a maximum pore size of 0.01 microns and RO membranes generally have a pore size of 0.0001 microns.

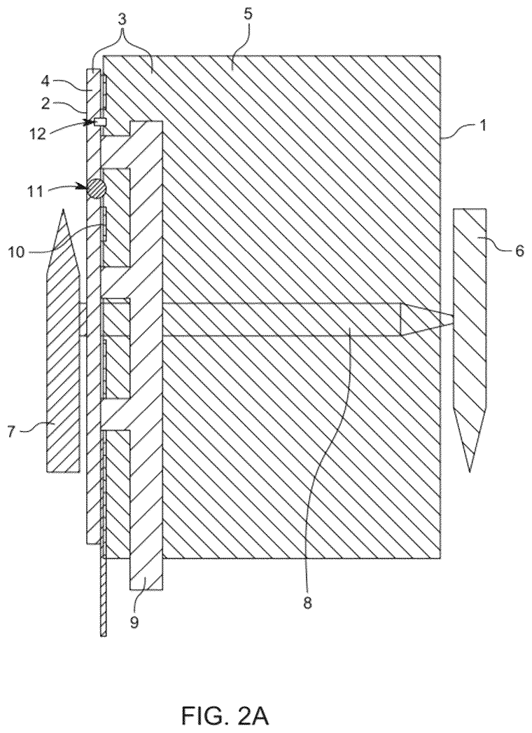

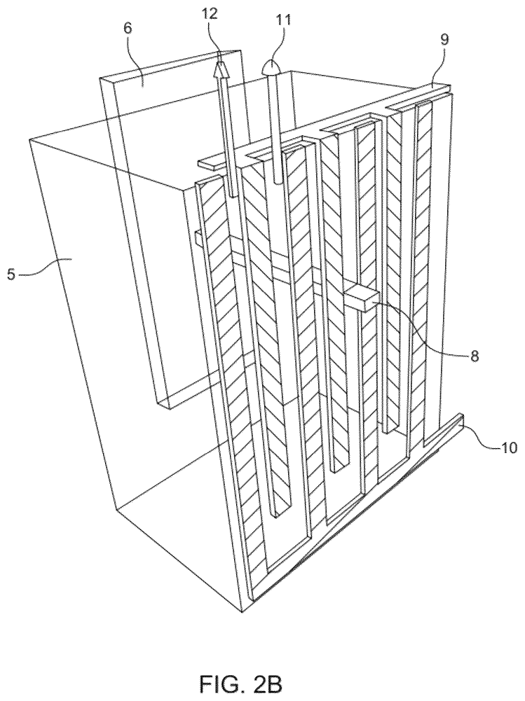

FIGS. 2A and 2B of the accompanying drawings illustrate one embodiment of a novel semi-permeable membrane 3 according to the presently disclosed subject matter which may be incorporated into a PRO or FO module to carry out the process as described above. The membrane is provided with electrodes 9, 10 which enable it to be used for hydrogen generation in addition to its conventional use.

Referring to FIG. 2A, a feed stream (saline solution, FS) 7 is delivered to a feed side 2 of the semipermeable membrane 3. The membrane 3 consists of a salt rejection layer 4 and support layer 5 with a series of parallel electrodes 9, 10 positioned between the salt rejection layer 4 and the support layer 5. During forward osmosis (FO) or pressure retarded osmosis (PRO), part of the feed stream 7 (saline solution) moves from the feed side 2 of semipermeable membrane through the salt rejection layer 4 (omitted from FIG. 1B for sake of simplicity) and support layer 5 to the opposite side 1 (draw side) as permeate 8. This permeate stream 8 has a very low salinity (around 2%) and thus has an osmotic pressure lower than the feed stream 7 (POf) and lower than the draw solution stream 6 (POr).

Movement of stream 8 (permeate) takes place under balance of osmotic and gauge pressures POr; POf; PGr; PGf. This stream 8 (permeate), exists only as a moving stream during active FO or PRO process. It cannot be extracted as liquid but due to its very low salinity it can be electrochemically split during transit through the body of semipermeable membrane 3. This is achieved by electrodes 9, 10 incorporated into the membrane 3 which allow a direct current to be applied to the permeate stream 8 causing the water to dissociate into hydrogen 11 and oxygen 12 which may then be collected for later use.

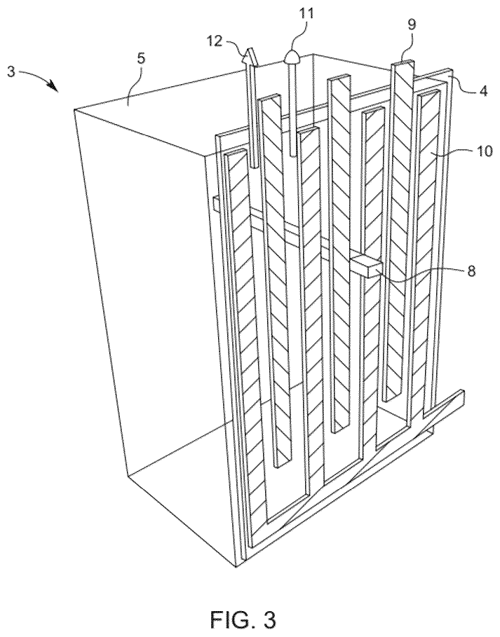

FIGS. 3, 4 and 5 of the accompanying drawings illustrate alternative embodiments of semi-permeable membranes 3 according to the presently disclosed subject matter, the membranes 3 being provided with electrodes 9, 10 in different positions within the membrane. Identical features already discussed in relation to FIGS. 2A and 2B are given the same reference numerals.

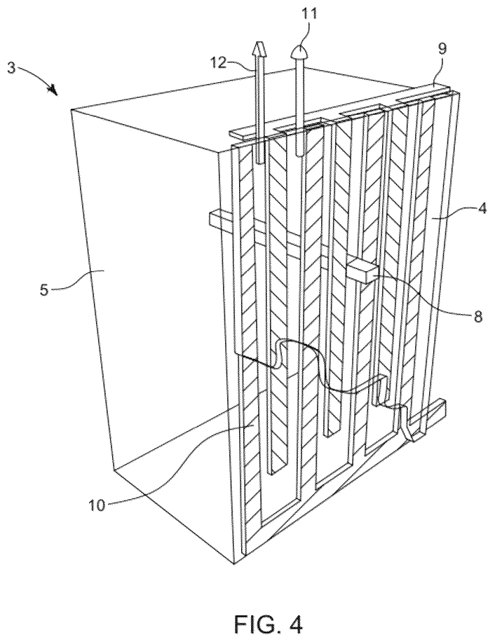

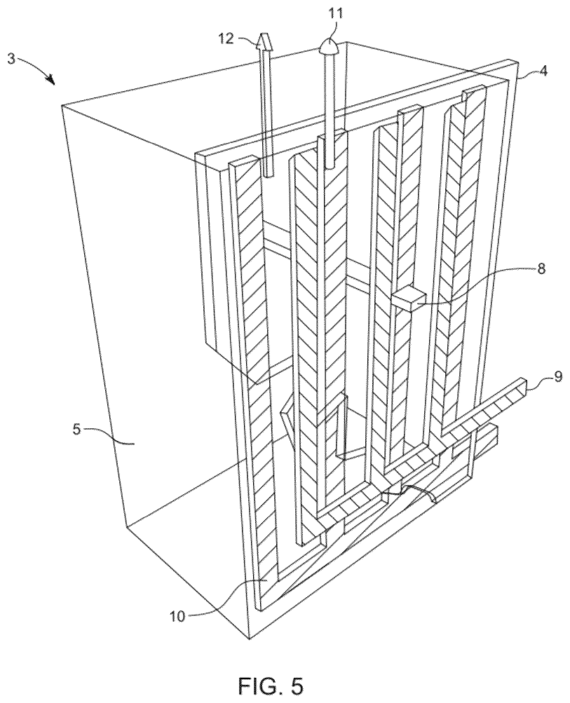

FIG. 3 shows the membrane 3 with both electrodes 9, 10 (anode and cathode) positioned externally on the surface of the salt rejection layer 4. In contrast, FIG. 4 shows membrane 3 with both electrodes 9, 10 positioned between the support layer 5 and the salt rejection layer 4. In FIG. 5, one electrode 10 is positioned between the support layer 5 and the salt rejection layer 4 with the other electrode 9 positioned on an external surface of the salt rejection layer 4.

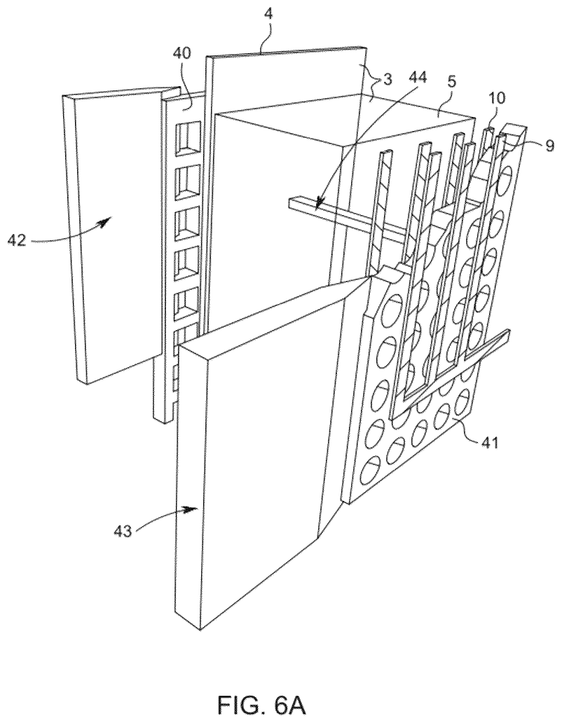

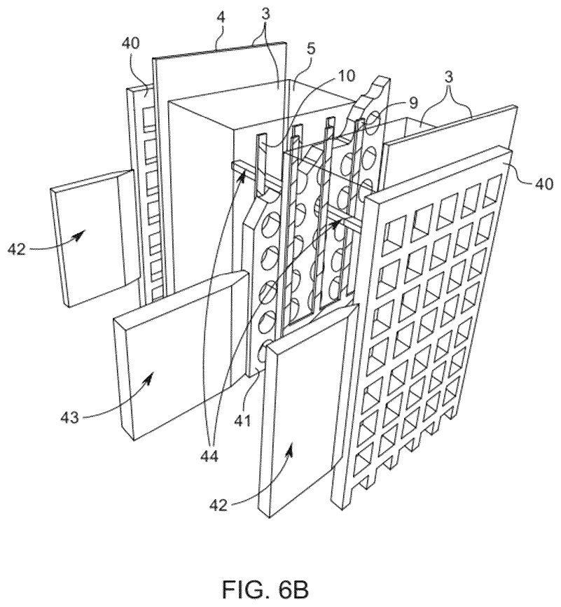

Additionally, the semi-permeable membrane may comprise a module having a permeate tube and flat membrane sheets wound around the tube to provide a membrane element and incorporating permeate and/or feed spacers (supporting layers between the membrane sheets). These types of membrane elements or modules may also be adapted to incorporate electrodes in accordance with the presently disclosed subject matter. FIG. 6A shows a fragment of such a membrane 3 arrangement. It is single fragment of RO membrane with raw feed flow 42 and permeate flow 43. Support layer 5 and salt rejection layer 4 forms entire membrane 3.

A permeate spacer 41 is provided on the support layer side 5 of membrane 3 and a feed spacer 40 is provided on the salt rejection side 4 of membrane 3. This is a typical arrangement presented in FIG. 6A. However, it is to be appreciated that other arrangements may be provided, such as positioning salt rejection layer 4 facing permeate spacer 41. Electrodes 9 and 10 are positioned on opposite sides of permeate spacer 41. In another embodiment, electrodes may be positioned on the same side (not shown). In other embodiments, three and more electrodes may be positioned on the same side or on both sides of permeate spacer 41 (again not shown). In other embodiments, one, two, three and more electrodes may be positioned on the same side or on both sides of the permeate spacer 41 and/or on feed spacer 40 (not shown). This arrangement of electrodes positioned on feed spacer 40 and/or permeate spacer 41, may be combined with electrodes positioned on salt rejection layer 4 and support layers 5 of membrane 3 as described above. The position of the salt rejection layer in some membranes may be orientated to permeate channel instead of feed channel (again this is not shown in the accompanying figures).

Thus, the electrodes 9, 10 may be incorporated into multiple types of filtration membranes and are not limited to those shown and described herein. This includes membranes that may consist entirely of a salt rejection layer 4 and do not have support layer 5 and/or feed or permeate spacers.

FIG. 6B shows a fragment of two membranes 3 arranged in mirror symmetry in RO module with arrows for the raw feed flow 42 and arrows for the permeate flow 43 passing between membranes 3. Permeate flow generated on the membrane 3 is shown as arrow 44, which joins permeate flow 43 coming from other membranes positioned in the module. This represents a typical mirror RO membranes arrangement format where the raw saline solution feed channel 42 includes feed spacer 40 and permeate channel 43 has permeate spacer 41 positioned in it.

Thus, it is to be appreciated that any type, number and arrangement of electrodes may be provided within the membrane to allow water splitting to be carried out. Two or multiple electrodes may be installed between salt rejection and support layers, the electrodes can be installed in the support layer only, in rejection layer only or the electrodes can be installed in both layers.

The electrodes must have the necessary conductivity and one of the electrodes may comprise the active or salt rejection layer 4. A preferred embodiment of the semi-permeable membrane has a salt rejection layer that also forms one of the electrodes. One preferred material for the electrode, which may also comprise the active or salt rejection layer 4, is graphene. However, another suitable material is titanium. The substrate for the electrode may, for example, comprise a mesh, plate, foil, cloth formed of fiber or a sintered body. Dielectric layers may also be incorporated into the membranes between the electrodes. The layers may be interconnected and may be produced by techniques such as casting or printing, gluing or growing.

The electrode (anode and/or cathode) may also be at least partially coated with at least one catalyst, such as one selected from the group consisting of iridium oxide, ruthenium oxide, tantalum oxide, titanium oxide, platinum, and platinum oxide, Cobalt, Cobalt oxide, Nickel, Nickel oxide and any combination thereof.

In embodiments where the electrode comprises graphene or a carbon fiber/cloth, the carbon substrate is preferably coated with mixed metal oxides (MMO) selected from Pt, Ir, Pt—Ir and Ru metals and any combination thereof.

Preferably, the carbons are substrates for coating with mixed metal oxides (MMO) selected from platinum (Pt), iridium (Ir), Pt—Ir, ruthenium (Ru) Cobalt, Nickel metals and any combinations thereof. In these embodiments, the MMO/C electrodes may be prepared by a two-step process comprising forming a sacrificial copper or nickel layer on the carbon via electroless or electrodeposition and displacing the sacrificial metal by Pt, Ir, Ru or Pt—Ir.

The present application is equally suitable for two, three or more electrode systems, such as cathode, anode and reference electrodes, or other. Additional non salt rejection layers (membranes) can be installed near to the electrodes.

As is known in the art, feed spacers are used in spiral wound reverse osmosis membrane modules to keep the membrane sheets apart as well as to enhance mixing. They are beneficial to membrane performance but at the expense of additional pressure loss. The feed spacers are a netting material placed between the flat sheets of a reverse osmosis membrane to promote turbulence in the feed/concentrate stream. Usually, feed spacers are made of plastic polypropylene.

A permeate or channel spacer is also known as a “permeate water carrier”, or “mesh spacer”. In the construction of a membrane element, the permeate spacer is placed between two layers of the flat sheet membrane. This spacer is used to prevent the RO membrane from closing-off on itself under the high pressure of operation. Permeate water will flow in a spiral path across the product channel spacer into the product collection tube. The permeate spacer is inside the envelope and creates a flow pass for permeate water. Additionally, it supports the membrane sheets mechanically against (high) feed pressure and therefore it is made of woven spacers with low permeability to have the required stiffness. Usually, permeate or channel spacers are made of woven thin plastic (e.g., a knit fabric called Tricot).

It is to be appreciated that the electrode (anode and/or cathode) may also comprise the feed or permeate spacer as discussed above, for example wherein the spacer is at least partially coated with an electrically conductive layer to make the spacer electrically conductive and/or a catalytic layer to make them electrocatalytically active as anodes (O₂ evolution) or cathodes (H₂ evolution) or both. The catalyst may be for example Pt, Ir, Ni, Cu metals or any combination thereof.

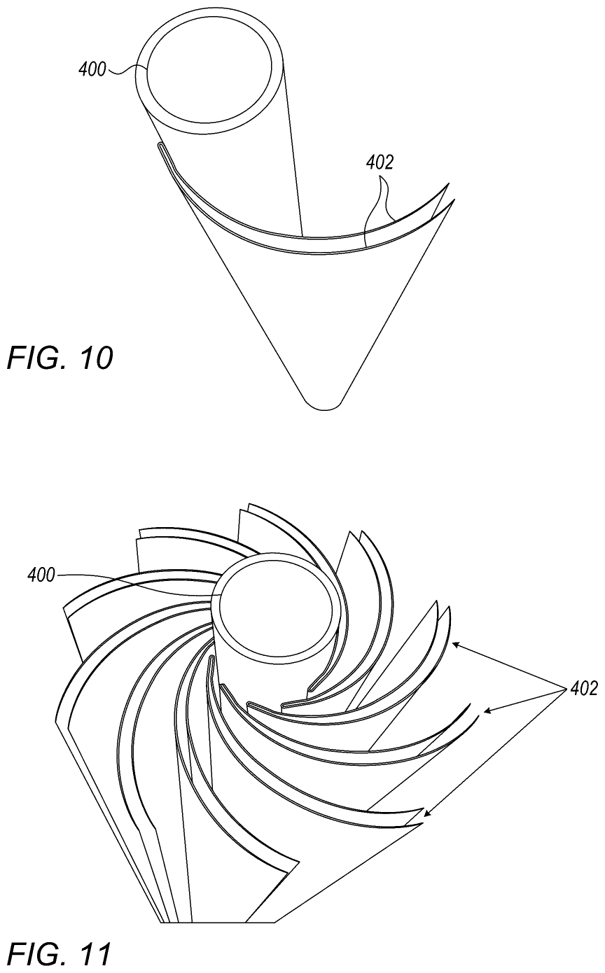

Alternatively, the electrode (either anode or cathode) may be coupled to the permeate or feed spacer, which is in mechanical co-operation with the permeate tube. An example of such an embodiment is shown in FIG. 10 of the accompanying drawings wherein two electrodes 402 are coupled to spacers attached at one end to a permeate tube 400. Any number of electrodes and spacers may be provided, as shown in FIG. 11 which has 20 electrodes 402, coupled to spacers, which are coupled at one end to the permeate tube 400. According to another embodiment of the presently disclosed subject matter, Titanium foil cladding to permeate and/or feed spacers with and without additional electricity conductors between titanium foil and plastic spacer.

Thus, the electrode is essentially the Titanium foil cladding.

It should be noted that it is within the scope of the presently disclosed subject matter where the Titanium foil acts essentially as the permeate and/or feed spacers. As such, the Titanium foil is by itself coupled to the permeate tube (further disclosure will be provided hereinabelow).

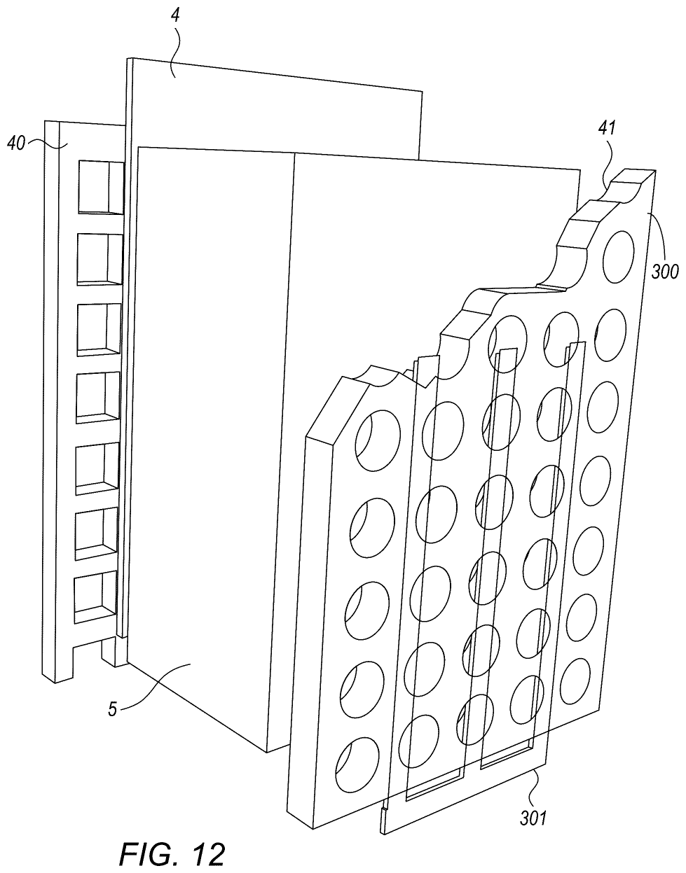

Reference is now made to FIG. 12 illustrating a Titanium foil cladding 300 to permeate and/or feed spacers with and without additional electricity conductors between titanium foil and plastic spacer.

In the example illustrated in FIG. 12, the Titanium foil 300 is cladded to the permeate spacer 41. However as specified above, such cladding could be performed to the feed spacer 40 as well.

According to one embodiment, the cladding is performed on one side of the permeate and/or feed spacers. According to another embodiment, such cladding is performed on both sides of the permeate and/or feed spacers.

According to one embodiment, the cladding my be done by application of vacuum.

According to such an embodiment, on one side of the permeate and/or feed spacers the foil is positioned and on the other side vacuum is applied. Such suction will adhere the Titanium foil 300 to the permeate and/or feed spacers.

The thickness of such Titanium foil 300 can be varied and depending of the electrical conductivity needed.

According to another embodiment, in addition to the Titanium foil cladding 300, electrical wires can be added to enable the electrical current transfer. Such is also seen in FIG. 12. Thus, as seen in FIG. 12, according to some embodiment, electrical wires 301 are also added to the permeate spacer 41. According to another embodiment, the Titanium foil is incorporated into the membrane module (assembly) and acts as the electrode (anode and/or cathode). According to another embodiment, also serves as a feed and/or permeate spacer.

It is within the scope of the presently disclosed subject matter where the thickness of the electrode (e.g., the Titanium foil) ranges between 1 micron (0.001 mm) to as thick as 3 mm.

According to one embodiment of the presently disclosed subject matter, the electrode (e.g., the Titanium foil) is at least partially corrugated (embossed) in a predetermined pattern. It is within the scope of the presently disclosed subject matter where the term corrugation refers to the act of shaping a surface of the corrugated element; in this case, the Titanium foil.

Corrugations are measured and categorized by the depth and spacing. The size of the corrugations determines the culvert roughness used. according to some embodiments, corrugations are measured from crest to crest (width or pitch) and valley to crest (depth).

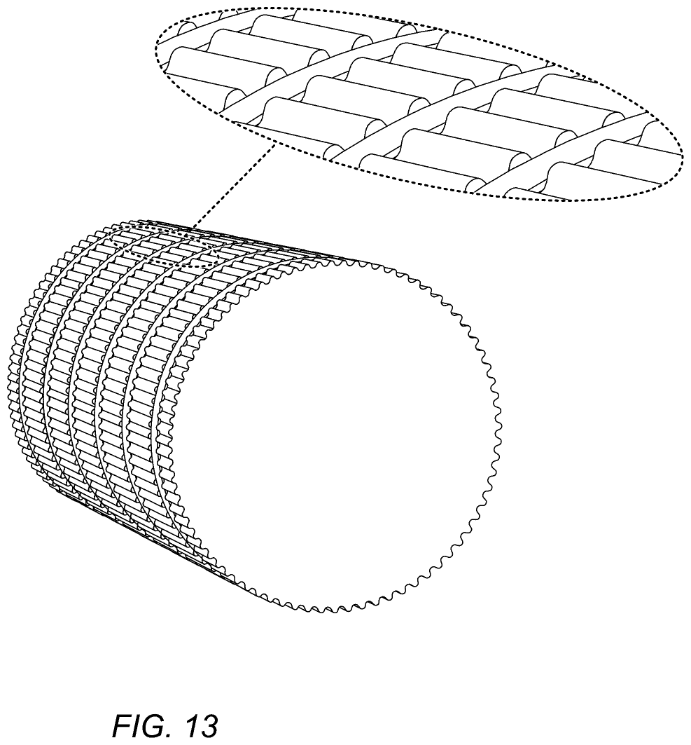

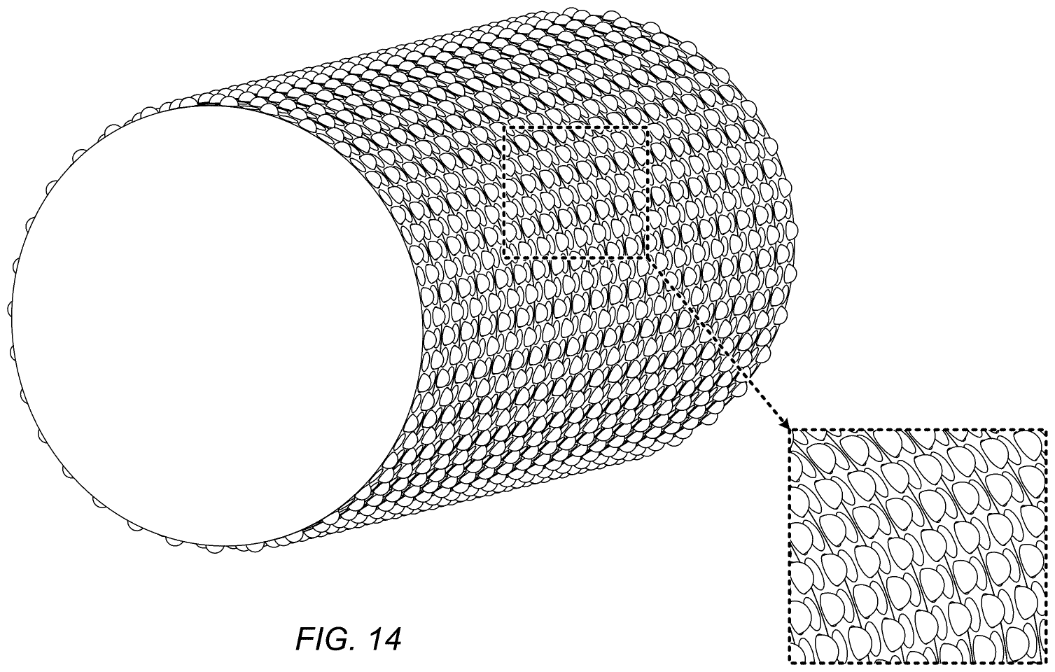

Reference is now made to FIGS. 13-14, providing examples of different corrugation patterns that can be used. However, it is within the scope of the presently disclosed subject matter to provide any corrugating pattern (embossing pattern).

It should be noted that it is within the scope of the presently disclosed subject matter where the electrode (e.g., the Titanium foil) is only partially corrugated and not corrugated along its entire cross section/length.

As disclosed above, according to one embodiment the electrode (e.g., the Titanium foil) is cladded onto at least one selected from a group consisting of permeate spacer, feed spacer and any combination thereof.

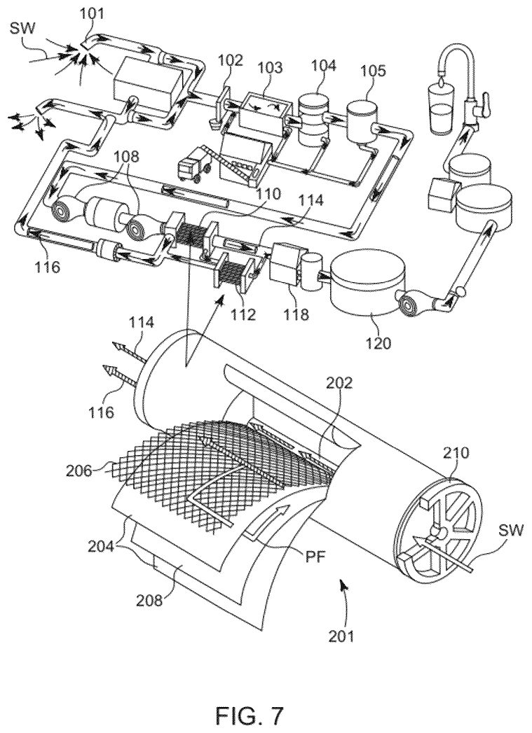

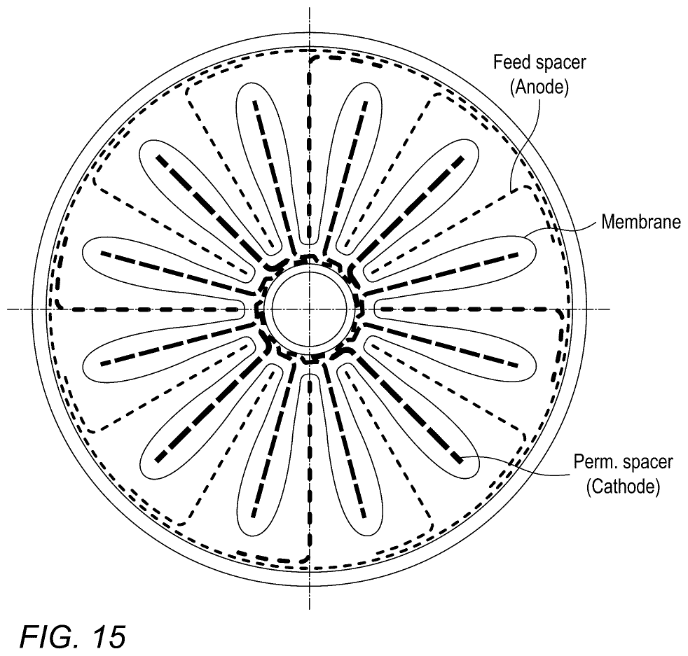

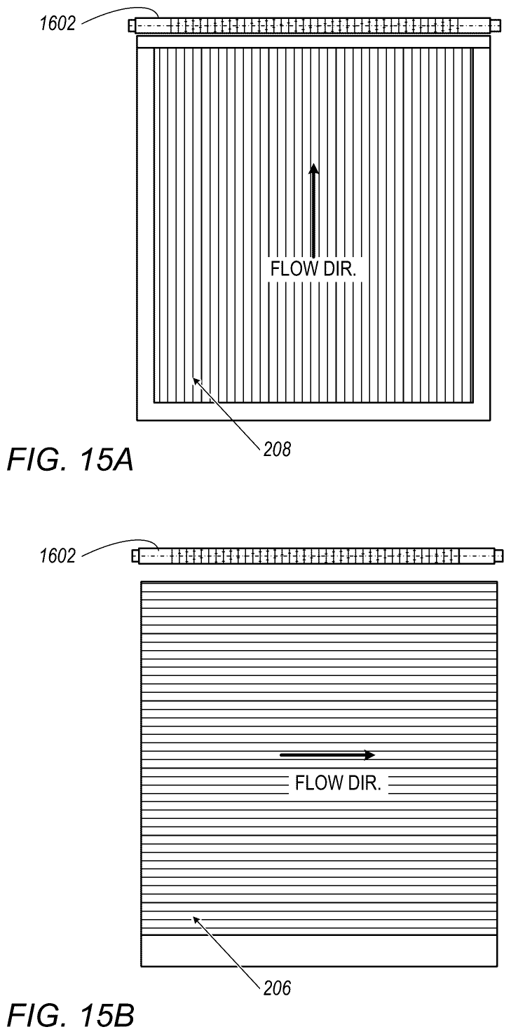

According to one embodiment the electrode (e.g., the Titanium foil) functions essentially as at least one selected from a group consisting of permeate spacer, feed spacer and any combination thereof. Reference is made back to FIG. 7, illustrating the membrane element, which comprises the at least 2 membranes enveloping at least one permeate spacer 208. And in between at least 2 membranes elements, at least one feed spacer 206 is provided. Thus, according to this embodiment, the electrode (e.g., the Titanium foil) substitutes at least one selected from a group consisting of permeate spacer, feed spacer and any combination thereof. Reference is now made to FIG. 15 illustrating such an embodiment. As seen in the figure, the electrode (e.g., titanium) replaces the feed spacer 206 (and thus, acting as the anode). Alternatively, or in addition to that, the titanium electrode can also replace the permeate spacer 208 (and thus, acting as the cathode for the generation of hydrogen).

As noted above, at least one catalyst may be provided on at least one or both of the electrodes (cathode and/or anode) to enhance the desired reaction, for example to facilitate oxygen and hydrogen generation and hamper chlorine evolution.

In one embodiment, the electrodes (cathode and/or anode) may be at least partially coated with at least one catalyst. Preferably, the catalyst is selected from at least one of the group consisting of iridium oxide, ruthenium oxide, tantalum oxide, titanium oxide, platinum, and platinum oxide, Cobalt, Cobalt oxide, Nickel, Nickel oxide and any combination thereof.

Thus, according to the above, the Titanium electrode (anode and/or cathode) can be both at least partially corrugated and at least partially coated with the catalyst.

According to another embodiment of the presently disclosed subject matter where at least one of the electrodes (e.g., the Titanium foil), which functions as the anode as well, also functions as at least one of the feed spacer and/or at least one of the electrodes (e.g., the Titanium foil), which functions as the cathode as well, also functions as at least one of the permeate spacer, each of the electrodes/anodes/feed spacer or electrodes/cathodes/permeate spacer is corrugated substantially the same.

Alternatively, each of the electrodes/anodes/feed spacer or electrodes/cathodes/permeate spacer is corrugated in a substantially different manner.

An example thereof can be seen in FIGS. 15a-15b which illustrate waves-like corrugation pattern of the spacers (FIG. 15a. illustrates the corrugation pattern of the permeate spacer; and FIG. 15b illustrates corrugation pattern of the feed spacer).

According to this embodiment, while the electrodes/anodes/feed spacer is waves-like corrugated in one direction, the electrodes/anodes/feed spacer is waves-like corrugated in one direction which is substantially different than the electrodes/anodes/feed spacer's corrugation. Specifically, in the example in FIGS. 15a-15b the corrugation of the electrodes/anodes/feed spacer is in 90 degrees relative to the corrugation of the electrodes/anodes/permeate spacer.

As seen in FIG. 15a, the waves-like corrugation of the permeate spacer is directed towards the permeate tube 1602 in order to facilitate the flow of the permeate towards the permeate tube 1602. According to this embodiment and as illustrated in FIG. 15b the waves-like corrugation pattern of the feed spacer is rotated at 90 degrees relative to the waves-like corrugation pattern of the permeate spacer.

According to one embodiment, the Titanium electrode (anode and/or cathode), which could serve as the spacers (permeate and/or feed spacers) is in physical connection with the permeate tube.

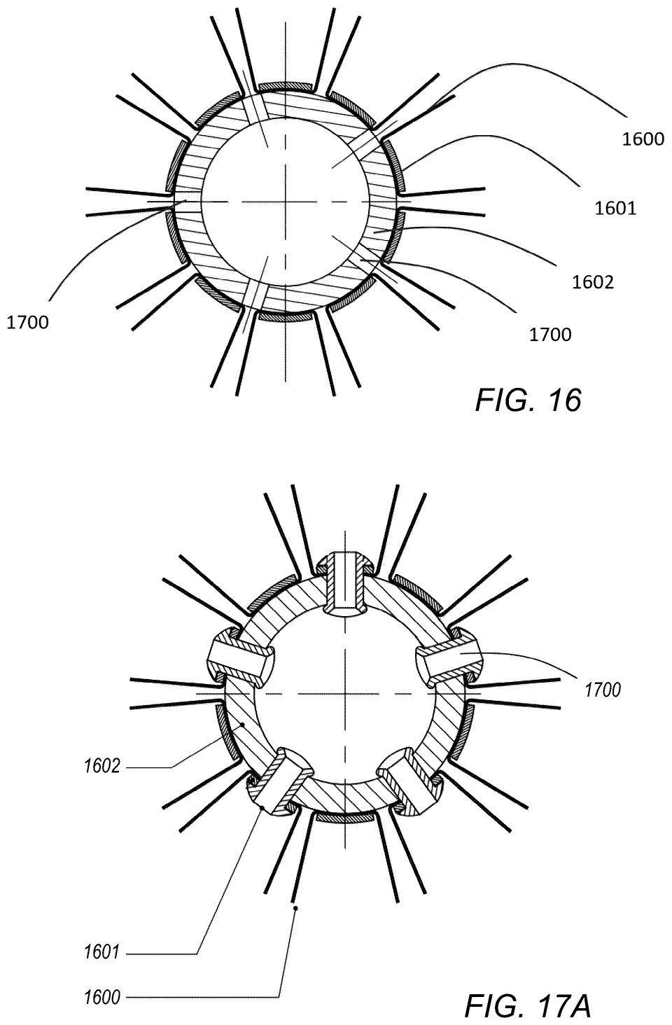

Reference is now made to FIGS. 16-22 illustrating exemplary embodiments of such coupling.

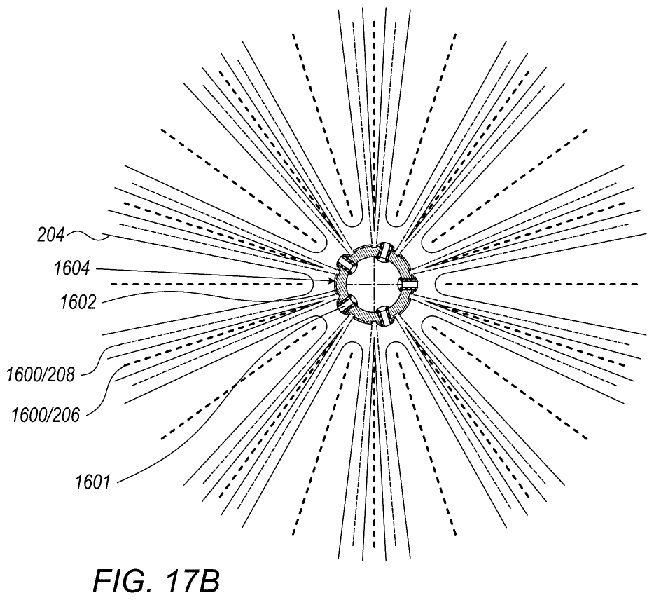

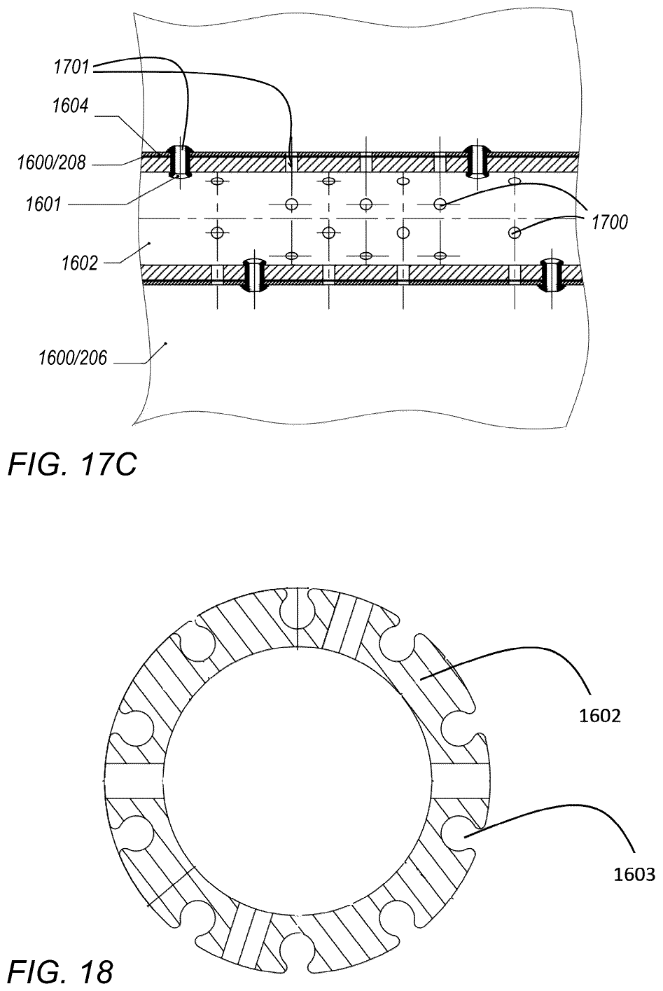

According to the first embodiment (see FIGS. 16-17a-c), the coupling/anchoring means could be any mechanical coupling means (e.g., rivets, screws, etc.) 1601, connecting the Titanium electrode 1600 to the permeate tube 1602.

According to another embodiment, in addition to the coupling/anchoring means 1601, an additional strips/flats bars 1604 could be provided to better secure the Titanium electrode 1600 to the permeate tube 1602.

Also illustrated in the figures are openings 1700 located on the permeate tube 1602 (for the collection of the permeate water/the product).

It should be pointed out that according to one embodiment, the openings 1700 are disposed on the permeate tube and according to another embodiment, the openings 1700 could also be positioned on the coupling/anchoring means 1601 (e.g., rivets with internal openings, as illustrated in FIG. 17a).

Reference is now made to FIG. 17b which illustrates the assembly of the titanium electrode 1600 functioning as permeate spacer 208 and/or as feed spacer 206. Also illustrated is the membrane 1600/204 disposed between permeate spacer 1600/208 and feed spacer. Also illustrated are the coupling means (e.g., rivets, screws, etc.) 1601, connecting the Titanium electrode 1600 (206/208) to the permeate tube 1602.

Reference is now made to FIG. 17c illustrating a cross section area of the permeate tube 1602. As seen in FIG. 17b, the assembly of the titanium electrode 1600 functioning as permeate spacer 208 and/or as feed spacer 206 is illustrated. Also illustrated is the membrane 1600/204 disposed between permeate spacer 1600/208 and feed spacer. Also illustrated are the coupling means (e.g., rivets, screws, etc.) 1601, connecting the Titanium electrode 1600 (206/208) to the permeate tube 1602. Also seen are the openings 1700 on the peripheral circumference of the permeate tube 1602. Additionally, or alternatively openings 1701 may be provided. Such openings 1701 are opening integrated in the coupling means 1601.

It should be noted that it is within the scope of the presently disclosed subject matter where the electrode 1600 functioning as permeate spacer 208 and/or as feed spacer 206 is simply welded to the permeate tube 1602. Specifically, the titanium electrode 1600 functioning as permeate spacer 208 is welded to the permeate tube 1602.

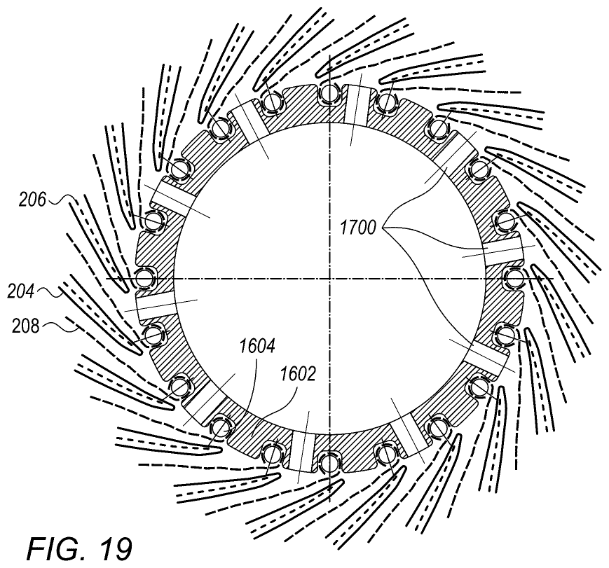

Reference is now made to FIGS. 18-19 illustrating exemplary embodiment of another coupling between the permeate tube and the Titanium electrode (cathode or another).

According to this embodiment, the permeate tube 1602 comprises at least one groove, 1603 into which the electrode will be disposed.

While FIG. 18 illustrates the permeate tube 1602 with the grooves 1603, FIG. 19 illustrates the assembly of permeate tube 1602 with the Titanium electrodes (permeate spacer or feed spacer) and the membranes.

As illustrated in the FIG. 19, the permeate spacer-Titanium electrode 208 is disposed within grooves 1603 (not shown) and at least one anchoring element 1604. The anchoring element 1604 is adapted to be at least partially disposed within groove 1603, thereby securing the permeate spacer-Titanium electrode 208 within groove 1603 of the permeate spacer 1602. Also, illustrated in the figures are openings 1700 located on the permeate tube 1602 (for the collection of the permeate water/the product).

According to one embodiment, the anchoring element 1604 is rubber-based anchoring.

According to one embodiment, the anchoring element is characterized by a cross-sectional shape selected from circular, elliptical, oval, rectangular, triangular, any combination thereof; or any other shape.

Also illustrated in the figure are the RO membrane, 204 and the feed spacer, 206. As noted above, the feed spacer 206 could also be Titanium electrode.

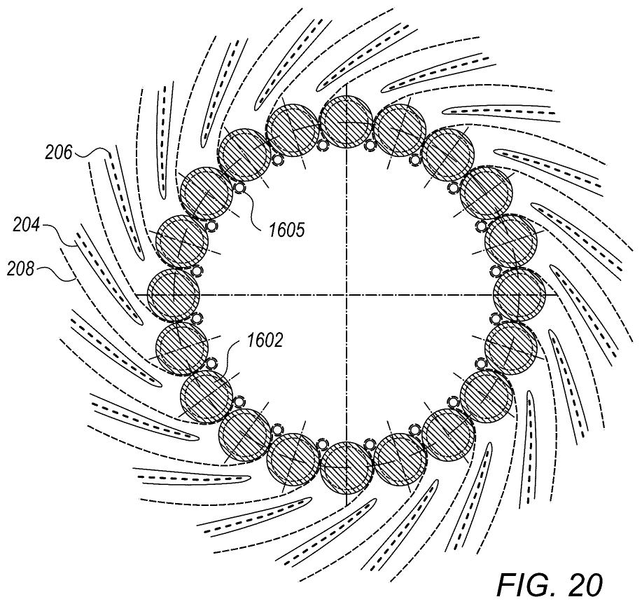

Reference is now made to FIGS. 20-22 illustrating another embodiment of the presently disclosed subject matter. According to which the permeate tube 1602 comprises a plurality of rod-like elements 1602a secured together.

According to this embodiment, the permeate spacer 208 comprises at least one bulging/protrusion element 2081 located on one peripheral end thereof. When assembled on the rod-like elements 1602a permeate tube 1206, the bulging/protrusion element 2081 is disposed in between each two rod-like elements 1602a. The coupling between all rod-like elements 1602a to form the permeate tube 1206 essentially provide the coupling of the permeate spacer 208 to the permeate tube 1206.

As disclosed above, the electrode (e.g., Titanium electrode) could be in addition to the spacers (feed or permeate) or replacing the same (and essentially functioning in the same manner).

As disclosed above, the Titanium electrode could be in the form of mesh, foil, plate, cloth, fiber, sintered body and any combination thereof.

As disclosed above, at least one of the Titanium electrodes could be at least partially coated with at least one catalyst. According to one embodiment, the catalyst is selected from a group consisting of iridium oxide, ruthenium oxide, tantalum oxide, titanium oxide, platinum, and platinum oxide, Cobalt, Cobalt oxide, Nickel, Nickel oxide and any combination thereof.

According to another embodiment, at least one of the Titanium electrodes could be at least partially corrugated (as illustrated in FIGS. 13-14).

As disclosed above and in accordance with all embodiments, the electrode can be incorporated within the element to allow electrochemical splitting of raw saline solution and/or permeate to create a smaller output of hydrogen generation together with a main output of residual brine stream and/or permeate product water.

The method of water split carried out within the membrane can be conducted using any one of the conventional techniques for water electrolysis, such as water electrolysis (WE), PEM Electrolysis, Microbial Electrolysis, Solid Oxide Electrolysis, Alkaline Electrolysis, or any other way of water split. Thus, the presently disclosed subject matter is not limited to one particular process of water split.

According to another embodiment of the presently disclosed subject matter, bi-polar electrodes are utilized. As used herein a bipolar electrode is defined as a floating conductor that can induce electrochemical reactions at its extremities when a sufficient voltage bias is applied to the opposing driving electrodes. In bipolar-systems, the two outermost anode and cathode (monopolar) are connected to an external electric power supply and internal electrodes are bipolar. The internal bipolar electrodes possess antithetical (opposed) charges on its two sides.

Bipolar electrochemistry (and use of bipolar electrode) is a phenomenon in electrochemistry based on the polarization of conducting objects in electric fields. Indeed, this polarization generates a potential difference between the two extremities of the substrate that is equal to the electric field value multiplied by the size of the object.

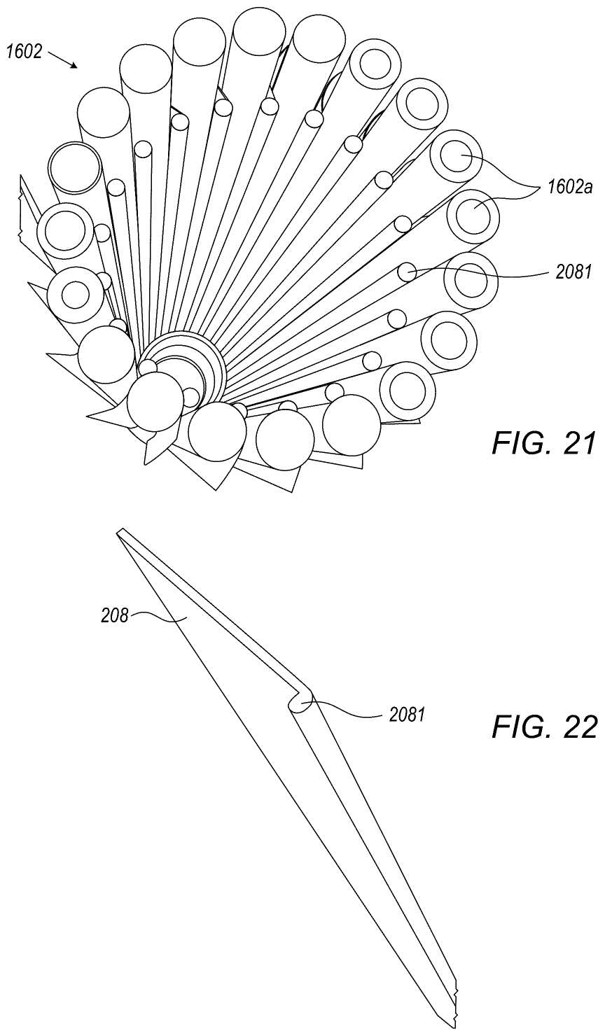

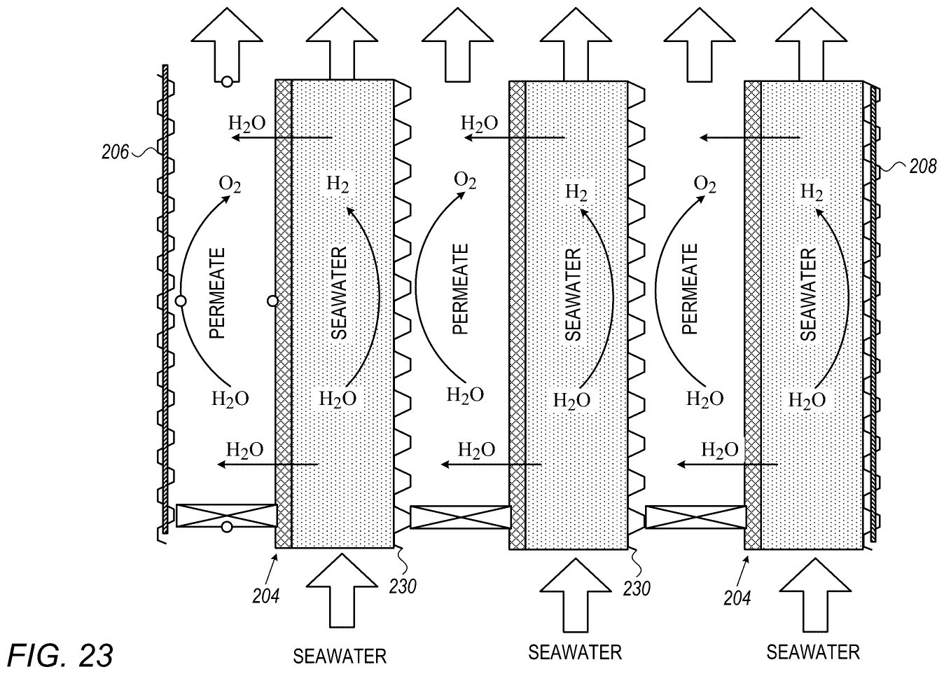

Reference is now made to FIG. 23 illustrating such an embodiment. According to this embodiment, the bi-polar electrode(s) is (are) floating and is (are) not connected to DC power supply. Only the two terminal electrodes (monopolar) are connected to power supply. Therefore, the system can be free of ohmic losses in the electrodes.

According to this embodiment, at least one membrane 204, at least one cathode 208, at least one anode, 206 and at least one floating electrode 230 is used.

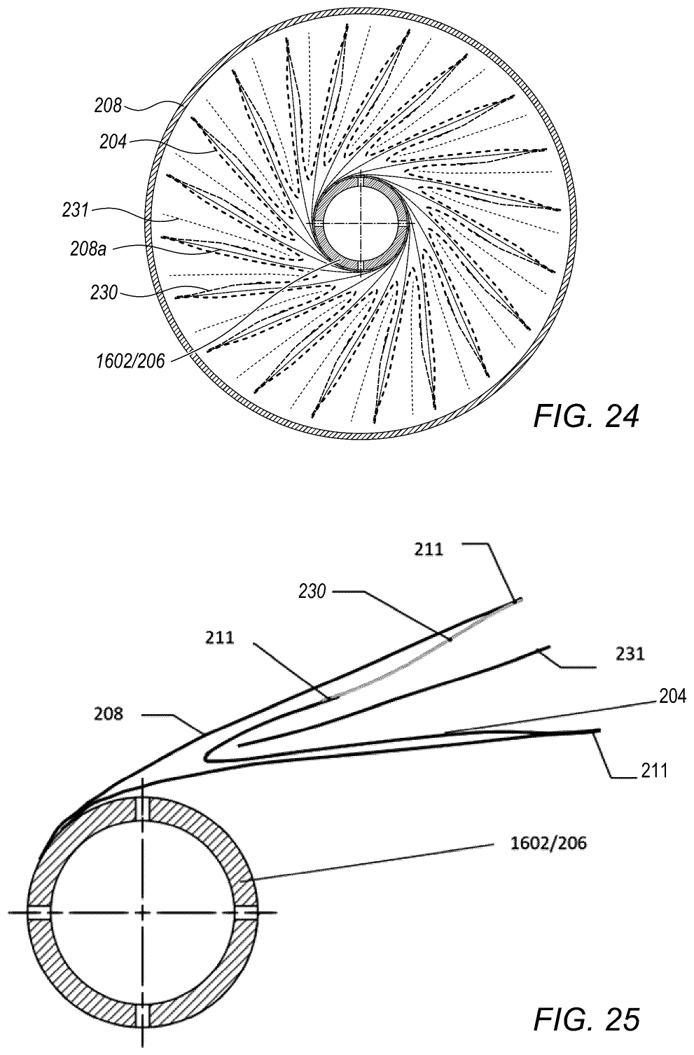

According to another embodiment of the presently disclosed subject matter, at least one floating electrode 230 is in mechanical communication with at least one membrane 204. Reference is now made to FIGS. 24-25 illustrating such embodiment. FIG. 24 provides an upper view while FIG. 25 provides a more closer view of the same.

As noted, according to this embodiment, at least one floating electrode 230 is in mechanical communication with at least one membrane 204. More specifically, the floating electrode 230 is glued to membrane 204 in at least one location 211.

According to this embodiment, the permeate tube 1602 also functions as the anode 206. The cathode 208 is the outer shell (the outer housing enclosing the entire membrane module).

According to some embodiments, additional feed spacer 231, if needed, are added.

According to some embodiments, additional permeate spacer 208a, if needed, are added.

Thus, according to one embodiment of the presently disclosed subject matter, at least a portion of one face of the floating electrode 230 functions as a cathode (where Hydrogen is produced); and, at least a portion of one face of the floating electrode 230 functions as an anode (where Oxygen is produced).

It should be noted that it is within the scope of the presently disclosed subject matter where at least one of said floating electrode 230 which functions as a cathode 208 also functions as the permeate spacer.

It should be noted that it is within the scope of the presently disclosed subject matter where at least one of said floating electrode 230 which functions as an anode 206 also functions as the feed spacer.

Thus, it is within the scope of the presently disclosed subject matter where cogeneration of drinking water and hydrogen production is enabled. According to one embodiment, water production/water filtration is the main product, and less than 1% of water involved in water purification/desalination process used as source of hydrogen production.

Furthermore, water purification/desalination/filtration membranes, according to the presently disclosed subject matter, act in two productions simultaneously and in the same time as a membrane dividing between bipolar and/or mono-polar and/or cathode and/or anode within the same system, in the same time of water purification/desalination.

According to one embodiment, the membrane is in a stack configuration or a spiral configuration.

As noted above, the membrane could be selected from a group consisting of UF, NF, MF, RO membranes and any combination thereof.

As disclosed above, the electrode (e.g., Titanium electrode) could be in addition to the spacers (feed or permeate) or replacing the same (and essentially functioning in the same manner). Thus, although the spacers are not shown in FIG. 23, it is within the scope of the presently disclosed subject matter where the spacers are added or alternatively function as the electrodes (mono or bipolar).

As disclosed above, the Titanium electrode could be in the form of mesh, foil, plate, cloth, fiber, sintered body and any combination thereof.

As disclosed above, at least one of the Titanium electrodes could be at least partially coated with at least one catalyst. According to one embodiment, the catalyst is selected from a group consisting of iridium oxide, ruthenium oxide, tantalum oxide, titanium oxide, platinum, and platinum oxide, Cobalt, Cobalt oxide, Nickel, Nickel oxide and any combination thereof.

According to another embodiment, at least one of the Titanium electrodes could be at least partially corrugated (as illustrated in FIGS. 13-14).

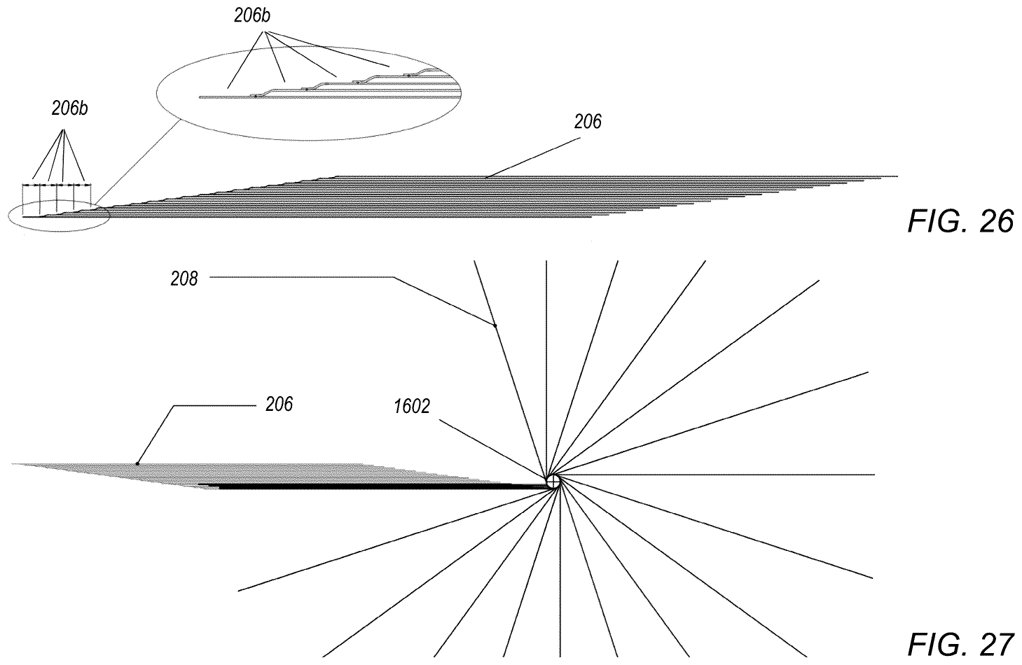

Reference is now made to FIGS. 26-27 illustrating another embodiment of the presently disclosed subject matter, according to which at least of the spacers (feed and/or permeate)/electrode are in mechanical communication with each other to one another to form one continuous (elongated) spacer/electrode.

According to one embodiment, the spacers are coupled (e.g., welded, glued or any other means to couple the spacers to one another) to one another to form one continuous (elongated) spacer/electrode.

In FIGS. 26-29 an example is illustrated where several the feed spacer/anode electrodes 206 are coupled to each other at at least one end thereof.

As seen in the figs. the feed spacer/anode electrodes 206 are coupled together (e.g., welded/glue or otherwise joint together) where each one is offset relative to the other. Thus, the first feed spacer/anode electrodes 206 is coupled to the second feed spacer/anode electrodes 206 at a distance 206b from the edges. The third feed spacer/anode electrodes 206 is coupled to the second feed spacer/anode electrodes 206, again, at a distance 206b from the edges.

It should be pointed out that all feed spacer/anode electrodes 206 are coupled to each other at a constant distance 206b, at a varying distance 206b or any combination (namely, some at a fixed distance 206b and some are at a changing distance 206b).

According to another embodiment, all the spacers/electrode are coupled to each other to form one continuous (elongated) spacer/electrode. According to another embodiment, a portion of the spacers/electrode are coupled to each other to form one continuous (elongated) spacer/electrode, while another portion is not.

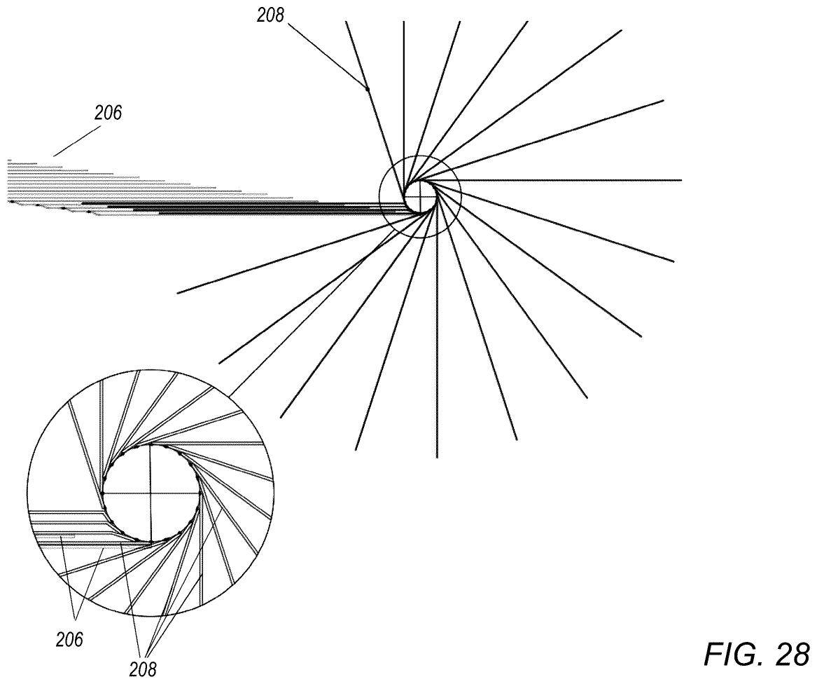

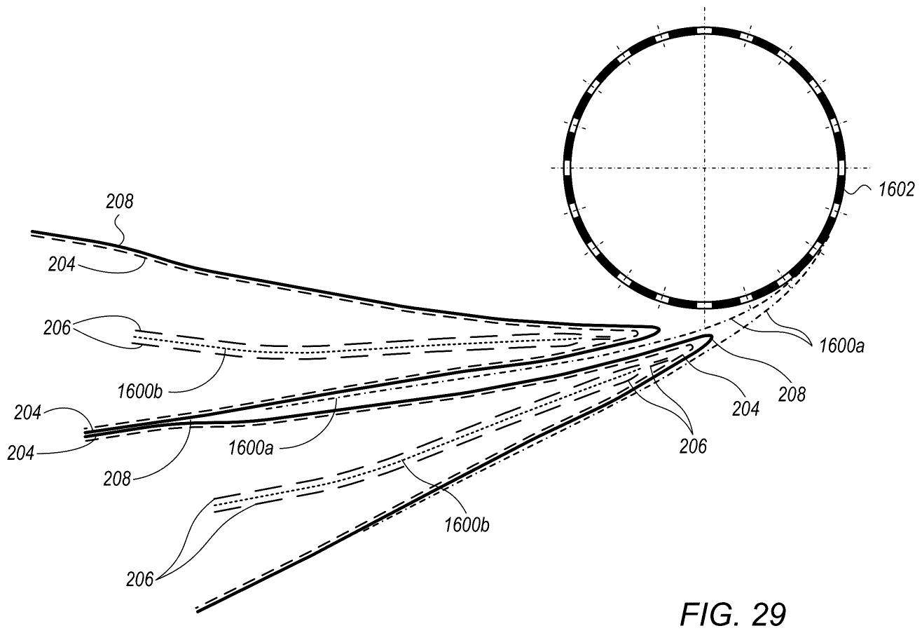

Reference is now made to FIG. 28 which is a closer view of the assembly of the feed spacer/anode electrodes 206 and the permeate spacer/cathode electrodes 208 (shown in FIGS. 26-27). As seen in FIG. 28, as the feed spacer/anode electrodes 206 are welded at one end thereof together, in between two coupled neighboring feed spacer/anode electrodes 206, is place at least one permeate spacer/cathode electrodes 208 and at least one membrane 204. Thus at least one permeate spacer/cathode electrodes 208 and at least one membrane 204 are placed between two neighboring feed spacer/anode electrodes 206 joint together. Such that, eventually all permeate spacer/cathode electrodes 208 (plus the membrane 204) are disposed in between two adjacently joint feed spacer/anode electrodes 206. Reference is now made to FIG. 29 illustrating another embodiment of the presently disclosed subject matter where both spacers (permeate and feed spacers) and electrodes (Titanium foils) are employed.

According to this embodiment, all anode electrodes 1600a are welded to the permeate tube 1602.

According to this embodiment, the envelope enclosing the permeate spacer 208 and the membrane 204 now includes also at least one anode electrode 1600a (e.g., Titanium foil) and two standard permeate spacers. The cathode electrode (e.g., Titanium foil) is positioned in between two feed spacers 206.

Thus, the following repeating 8 layers are provided:
1. permeate spacer 208,
2. membrane 204,
3. feed spacer 206,
4. cathode electrode 1600b,
5. feed spacer 206,
6. membrane 204,
7. permeate spacer 208,
8. anode electrode 1600a

According to one embodiment, the electrode (anode or cathode) could be any of the disclosed above (e.g., at least partially corrugated, in the form of a mesh, with coating of at least one catalyst etc.).

Different types of hydrogen and oxygen evacuation systems (not shown on drawings) may be applied to remove the gases from the membrane system. Preferably, hydrogen and oxygen are evacuated from the membrane element or module together with the water stream in which they were generated. Extraction of hydrogen and oxygen may then take place in a degasifier. The solubility of hydrogen and oxygen in water is very different enabling extraction of hydrogen to take place in the degasifier at a pressure at which oxygen is still dissolved. Oxygen together with water stream may then go to next degasifier with a lower gauge pressure, where oxygen may then be extracted. Alternative, a gas separation membrane may be utilised.

The presently disclosed subject matter allows fluids produced during treatment of water, such as seawater, brine and brackish water to be electrochemically split to provide hydrogen in addition to the treated water.

In an embodiment utilising RO-type membranes for desalination of feed water, one RO module may be provided with several membrane elements and feed seawater is concentrated as it moves from one membrane to the next membrane element in the module. For example, the first element in a module may have seawater 3.5% TDS and in the 8th membrane element 8% TDS. The water electrolysis will be different in different membrane elements having different salinity. The electrical system may be adjusted to provide different electrical current (voltage) to different membrane in module.

Conventionally, one RO module contains 5-8 membrane elements. According to one embodiment, the electrodes for water split on only the few first elements in the pressure vessel where permeate has less or more dissolved solids, and electrical conductivity is less or more which increases efficiency for split.

Preferably, only part, at most 5% (but preferably less than 2.5%), of the desalinated permeate stream produced during the RO process is split into hydrogen and oxygen.

This provides an important technological benefit in that permeate is never free from dissolved suspended solids.

FIG. 7 of the accompanying drawings illustrates a conventional seawater desalination plant that may be adapted to include membranes with electrodes to provide a dual water desalination and hydrogen generation plant. In brief, sea water SW is delivered, via intake channel 101, through various pre-treatment sites 102, 103, 104, 105 before being pumped under pressure by virtue of pumps 108 through multiple reverse osmosis passes 110, 112 to form desalinated product water 114 and concentrated sea water or brine 116. The product water may be subjected to post-treatments 118 and held in a holding tank 120, while the brine 116 is be discharged back into the sea via a discharge channel 122.

The reverse osmosis passes 110, 112 are each made up of multiple membrane elements 201, one of which is exemplified and expanded in FIG. 7. A central perforated product tube 202 extends through the centre of each element and is surrounded by sheets of semi-permeable membrane 204 wound around the tube and separated therefrom by a feed spacer sheet 206 and a permeate spacer sheet 208. An anti-telescoping cap 210 is provided at each end. As discussed above, a raw saline feed solution is fed into one end of the element 201 to provide permeate stream 114 and residual brine stream 116 with a permeate flow PF through the layers of the element. Electrodes (not shown) can be incorporated within the element to allow electrochemical splitting of raw saline solution and/or permeate to create a smaller output of hydrogen generation (not shown) together with a main output of residual brine stream 116 and/or permeate product water 114.

The process and system for simultaneous water treatment and electrochemical splitting of water according to the presently disclosed subject matter addresses many problems associated with prior art generation of hydrogen from seawater and other water sources.

For example, the possibility of cathodic precipitation of CaCO₃, Ca(OH)₂, Mg(OH)₂ and other species in the hybrid reactors proposed by the Applicant for simultaneous water treatment and H₂ production is significantly lower due to (i) very low current density, (ii) very high water flux, and (iii) the pH buffering capacity of seawater (relevant only if cathodes are located in feed and/or in concentrate compartments).

Furthermore, the chlorine evolution reaction in seawater electrolysis can be depressed due to the very small anodic current density of ≈1 mA/cm².

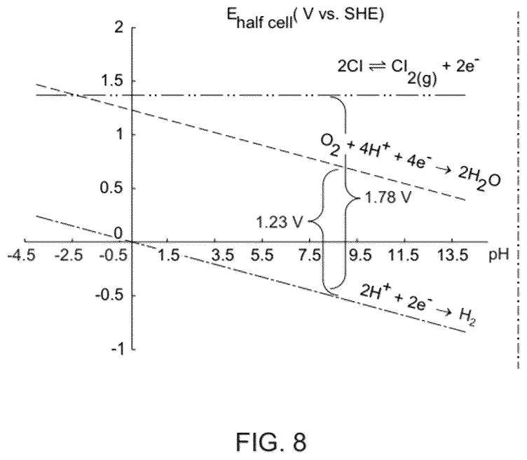

This is illustrated in FIG. 8 of the accompanying drawings which is a graph showing reversible potentials for chlorine evolution, oxygen evolution and hydrogen evolution reactions as a function of pH. T=25° C., [Cl⁻]=20 g/L fugacity of gases=1, no complexation, infinite dilution. This shows the values of reversible potentials (vs. SHE) for oxygen evolution (Eq. (3) supra) chlorine evolution (Eq. (6) supra), and hydrogen evolution (Eq. (4) supra) as a function of pH at conditions typical for seawater electrolysis (i.e., [Cl⁻]=20 g/L, fugacity of gases=1, no effect of complexation, infinite dilution). In WE the electrode potential for anodic reactions must be higher than the reversible potential. For cathodic H₂ production the cathode potential must be lower than the reversible potential of this reaction. As it is show in FIG. 8, the minimal cell potential (i.e., difference between anode and cathode potentials) required for chlorine evolution in seawater (pH≈8.1) is 1.78 V. On the other hand, the minimal cell potential required for oxygen evolution on an anode and hydrogen evolution on a cathode is only 1.23 Volt. Consequently, there is a range of cell potentials at which only oxygen will be produced on the anode and hydrogen will be produced on a cathode. Normally, this maximal cell potential limits the anodic current density to the very low current density of only few mA/cm². The current densities typical for alkaline water electrolysis is 200-400 mA/cm², and 600-2000 mA/cm² for PEM water electrolysis and thus, chlorine generation would be a problem. In contrast, the very small current density applied in the presently disclosed subject matter allows chorine generation to be depressed.

Furthermore, the proposed technique has the same thermodynamics as the conventional water electrolysis processes. Generally, operation at higher current density (i.e., larger production rates per reactor volume) requires higher energy input (or cell potential), while the energy/H₂ ratio increases at higher current densities. In other words, very low current densities that will be utilised for the process of the presently disclosed subject matter is expected to result in lower electrical energy consumption for hydrogen production compared to the state-of-the-art technologies.

The main reasons for this lower energy consumption are as follows: (1) lower activation overpotential is required to achieve lower current density, (2) very low diffusion and concentration overpotentials due to very effective mass transport in the proposed systems, (3) gas generation at no formation of bubbles. The last is due to a relatively low H₂ and O₂ production rates and very high flowrates of water that will result in complete dissolution of generated gases. Conventional water electrolysis systems cannot be operated at very low current densities because the footprint of the H₂ production system and construction costs would be unreasonably high.

In this respect, one of the main requirements to modern water electrolysis processes is low energy consumption at sufficient (i.e., >200 mA/cm²) current densities. High current density is required to decrease the construction costs, the footprint, and amounts of expensive materials, such as catalysts, membranes, bipolar plates, etc. To put it simply: construction of large conventional water electrolyzer operated at very low current density is economically unfeasible due to very high construction costs that would diminish the benefits of low energy consumption.

However, the integration of a hydrogen-producing process in conventional water desalination/filtration systems according to the presently disclosed subject matter is possible without any increase in their size or any significant decrease in water treatment performance. For example, permeate and feed spacers of RO, NF, UF, and FO modules, as well as membrane layers of NF, MF and UF membranes can be used as they currently are for separation of anodes and cathodes incorporated therein to provide the desired hydrogen generation. Consequently, the capital costs of the proposed H₂ production systems are expected to be relatively low, as they utilize materials, water preconditioning systems, and other units that already exist in pressure-driven membrane filtration processes.

Another important potential advantage of low current density operation is a possibility to apply cheap catalysts. This is because the rate of catalyst's wear is normally faster at higher current densities. This is an important reason for utilization of noble metal catalysts in conventional PEM electrolyzers. To summarize: in spite of the fact that the proposed technologies will have to utilize larger amounts of materials (per unit volume of generated H₂), the attributed hydrogen costs are expected to be lower to the conventional WE process due to the longer service life and significantly lower price of the materials.

Conventional water electrolysis electrodes comprise the “real electrode” which is a very thin (≈few microns) layer of catalysts, and secondary layers, such as a gas diffusion layer (GDL). The GDL is used to achieve fast mass transport of gaseous products from the electrode, and to drive electrons to (or from) the electrode. The GDLs of modern PEM water electrolyzers contain hydrophobic particles for fast transport of gaseous species. Next to the GDL the current collector is used to provide a flow of electrons to (or from) the GDL and the catalyst layer. The current collectors have flow-fields to distribute water on the electrode surface and to collect the produced gases. The thickness of current collectors is normally ≥3 mm and they are made of highly conductive material (e.g., graphite, composite of polymer and conductive particles, or metals).

In contrast, the electrodes of the electrolysis cells proposed by the semi-permeable membranes of the Applicant must be made of conducting fibers which are relatively long (i.e., up to 100 cm inside the membrane) and relatively thin (apparently up to 100 μm). This geometry would be barely possible in conventional WE operated at high current density. This is due to a high resistance of fiber-type electrodes. However, a simple calculation shows that this fiber type geometry is applicable in the systems and processes proposed herein:

Assumptions: thickness of the electrode=100 μm, area of the membrane=100.100 cm·cm, fraction of cross-section occupied by electrodes=50%, current density=3 mA/cm², effective electrolysis area is equal to membrane area.

Considering the parameters assumed above the cross-sectional current density (the ratio between current and cross-section of fiber electrodes) becomes ≈0.6 A/mm². This means that if the electrodes have electrical conductivity of 1.27-105 (S/m) (typical for graphite in basal plane) the ohmic voltage drop in 100 cm long electrode at a current of 30 A will be only ≈50 mV. This simple calculation shows that the proposed electrochemical cells are feasible if fiber type electrodes are made of material with high electrical conductivity (i.e., within a range of stainless steel or titanium).

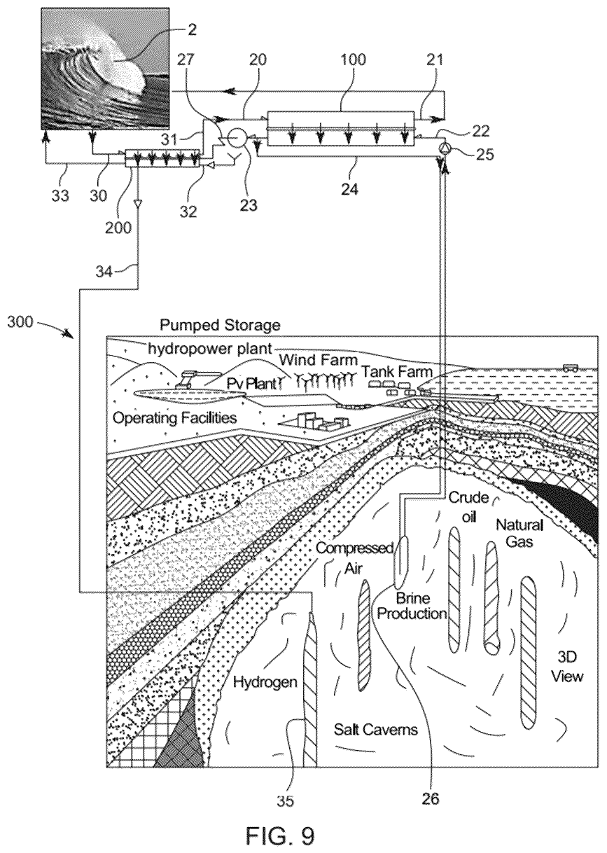

FIG. 9 of the accompanying drawings illustrate one scheme which may incorporate the system for generating hydrogen as hereinbefore described. In particular, the scheme allows for production of green energy using osmotic power generation from salt domes, the energy then being utilised for water split as hereinbefore described followed by storage of the hydrogen in empty salt caverns. In this manner, the presently disclosed subject matter provides an extremely energy efficient manner for the production of green energy in the form of hydrogen.

The scheme involves 3 cycles; cycle 100 involving efficient energy generation by PRO using the different salt concentrations between sea water 2 and dissolved salt water from salt domes 26; cycle 200 involving hydrogen generation from water electrolysis using the electricity produced in cycle 100 and cycle 300 which evacuates the hydrogen produced in cycle 200 and delivers it for storage in salt dome caverns 35 formed during salt extraction for the PRO in cycle 100.

In further detail, cycle 100 creates electricity using Pressure Retarded Osmosis process (PRO). The PRO is driven by the difference in salinity between highly concentrated salt 10-25% (draw solution DS) dissolved from salt domes 26 and seawater 3.6-4.5% (the feed solution FS). The dissolution of salt rock in salt caverns 26 as an option can take place under high gas pressure PGr which can be of about 200 bar and forms the draw solution. Alternatively, the dissolution can take place under atmospheric pressure. This draw solution is delivered to a first PRO module 100 by means of pump 25 via pipe line 23 and enters the first side of the module 100 via inlet 22 the first side. The feed stream (FS) enters the second side of the PRO module 100 via inlet 20. Part of the feed stream penetrates from the second side to the first side of the membrane 3 as low salinity permeate and mixes with the draw solution. A mix of the draw solution and permeate then exit module 100 via outlet 23. Part of this mix is directed to turbine 27 for electricity generation.

The residual amount of the feed stream is discharged from module 100 via outlet 21 to environment (for example, the sea as shown in FIG. 5)

The electricity generated in turbine 27 or similar device from the output from module 100 is then directed to a Forward Osmosis (FO) module 200 as energy source for electrochemical water split into hydrogen and oxygen, with the low salinity water for water split coming from FO process and the water split being achieved by the incorporation of a membrane according to the presently disclosed subject matter into the module that has electrodes for effecting electrolysis. Sea water 2 may be used for the feed solution 30.

Module 200 FO from construction point of view is similar to PRO module 100. Movement of permeate stream from the feed side of membrane to the draw side also takes place under balance of osmotic and gauge pressures Por; Pof; PGr; PGf. However, the difference between modules 100 and 200 is in the gauge pressures PGr; PGf. On module 200 the PGr and PGf are low and permeate movement from the FS side to the DS side takes place mostly under the difference in osmotic pressures Por′ and Pof′. The membrane has electrodes (i.e. 9,10 in FIGS. 1A to 4) and optionally an additional reference electrode (not shown in drawings). These electrodes, together with the electricity from module 100, allow splitting of the low salinity permeate stream to take place producing hydrogen and oxygen. Any residual water 33 may be returned to the sea 2.

It Is to be appreciated that the semi-permeable membranes incorporating electrodes according to the presently disclosed subject matter may be installed in module 100 and module 200, thus allowing water split to take place on module 100 and module 200 at the same time. Alternatively, the electrodes can be installed in module 100 only or in module 200 only.

Following production of hydrogen in cycle 200, the hydrogen is then stored in salt dome caverns 35 produced during salt extraction for PRO process 100.

The integration of electrochemical hydrogen production in RO membrane or UF/MF filtration processes provides significant and surprising benefits over prior art electrochemical treatment of water. The combination of water treatment and hydrogen production processes in one module is expected to significantly decrease operational and capital costs of hydrogen gas production, and to create an added value to water treatment facilities. The proposed technologies are expected to have significantly lower energy consumption than conventional water electrolysis techniques. The hybrid processes can be operated using cheap catalysts with very long operational life. These novel and inventive systems and methods according to the presently disclosed subject matter perform simultaneously pressure-driven membrane filtration of water (e.g., reverse osmosis, forward osmosis, nanofiltration, ultrafiltration) and electrochemical splitting of water using the same hybrid reactors.

It is to be appreciated that modifications to the aforementioned membrane, process and systems may be made without departing from the principles embodied in the examples described and illustrated herein.

### EXAMPLES

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable subcombination or as suitable in any other described embodiment of the presently disclosed subject matter. Certain features described in the context of various embodiments are not to be considered essential features of those embodiments, unless the embodiment is inoperative without those elements. Various embodiments and aspects of the presently disclosed subject matter as delineated hereinabove and as claimed in the claims section below find experimental support in the following examples.

### Example 1—Cobalt Coating of the Electrode (Titanium Foil)

Preparation of Titanium Foil Electrodes Coated with Co₃O₄ Catalyst
1.a. Pretreatment of Ti Foils-Chemical Etching

According to one example of the presently disclosed subject matter, Titanium foil of any desired shape is degreased in isopropanol for at least 10 hours.

The foils are then etched in a boiling 6.0 M HCl solution for 3-40 minutes. Successful etching is evident from the vigorous formation of hydrogen bubbles on the Ti surface. The HCl solution turns purple as titanium is oxidized and the acid is consumed. To ensure consistent results, the HCl solution should be replaced periodically if reused for electrode etching.

1.b. Pretreatment of Ti Foils-Mechanical Etching (Sandblasting)

A second option for pre-treatment of the electrode (Titanium foil) before the coating is sandblasting.

For this embodiment, any sandblasting technique may be used. One example could be by utilizing a sandblasting gun aimed at the electrode's surface at a predetermined angle range, distance range, and pressure ranges.

According to one embodiment, the sandblasting gun emits Aluminum oxide pellets onto the electrode (titanium foil). However, any kind of pellets could be used.

As with the chemical etching, the goal is to remove the oxide layer from the electrode's surface (titanium foil) and roughen it.

Essentially, the quality of the electrode's performance (electrochemically-wise) is determined by both the quality of the coating as well as by the profilometer to measure the level of roughness.

2.a. Preparation of Co-Precursor Solution (Cobalt Acetate Tetrahydrate)

According to one embodiment of the presently disclosed subject matter, Nitrate or acetate salts of cobalt, such as Co(NO₃)₂·6H₂O or Co(CH₃COO)₂:4H₂O, are used as precursors.

Suitable solvents include water or ethanol.

The salt concentration should be 10 gCo/L or higher. To prepare the desired volume of precursor solution, the salt is dissolved in the chosen solvent using a glass vessel, magnetic stirring bar, and a magnetic stirring plate.

2.b. Preparation of Co-Precursor Solution (Cobalt Nitrate Hexahydrate)

Another alternative to prepare the co-precursor solution (Cobalt nitrate hexahydrate) is by preparation of a supersaturated solution of Cobalt nitrate hexahydrate in DI water (deionised water). According to said example, the salt is dissolved in the DI water using glass vessel, magnetic stirring bar and a magnetic stirring plate.

### 3. Precursor Application of the Co-Precursor on the Electrode (Titanium Foil)

3a. First Embodiment-Dip-Coating.

Next, the electrodes are dip-coated with the co-precursor.

According to this example, the electrodes (Ti foils) are vertical positioned to be inserted into the co-precursor solutions.

Means (e.g., fixating means) are taken in order to prevent bending or vibrations of the electrode during the dip-coating process.

Dip-coating can be performed using a conventional dip-coating machine, which vertically inserted the electrodes (Ti foils) into and out of the cobalt precursor solution.

Alternatively, the cobalt precursor solution can be moved while the electrodes (Ti foils) remain stationary. In this approach, the precursor solution is first poured into a vessel containing the electrodes (Ti foils). After a desired immersion time (e.g., 1-30 minutes), the solution is removed from the vessel using a pump at a flow rate required to achieve the desired dip-coating velocity, typically in the range of 0.01-30 mm/s, most preferably, 0.1-4 mm/s.

3b. Second Embodiment of Precursor Application

The cobalt precursor solution can be applied using brushing or spraying, such as air-brushing.

When air-brushing is used, it is recommended to spray the precursor onto electrode (Ti foil) preheated to 50-100° C. to facilitate solvent evaporation.

4. Drying of electrodes (Ti foils) dip-coated in Co-precursor solution.

After dip-coating the electrode (Ti foils) must be dried.

The drying can be done at room temperature, or in an oven at elevated temperature. Drying time varies between 15 minutes to several hours. Drying temperature in an oven is 50-180° C.

Additional heat treatment at 250° C.-350° C. can be used to improve adhesion of Co₃O₄ to electrode (Ti substrate).

5. Calcination of Ti Foils Loaded with Co-Precursor

Calcination is performed in air at a temperature of 200-550° C.

According to one embodiment, the best performance of Ti/Co₃O₄ anodes was achieved after calcination at 350° C. The duration of calcination can range from 5 minutes to 3 hours.

The oven may be preheated to the desired temperature, or alternatively, the Ti foils can be placed in the oven and heated to the target temperature at a controlled ramp rate. After the temperature stabilizes, the foils are calcined for the desired duration and then cooled to room temperature inside the oven.

It should be noted that according to another example, the process of calcination performed is a furnace by ramping up the temperature to the desired level at a rate of 2° C.-10° C. per minute. Once the desired temperature is reached, the temperature is maintained for a certain period of time.

Afterward, the heating is stopped, and the furnace cools gradually to room temperature. This process is intended to avoid thermal shock and the formation of cracks.

### 6. Application of Additional Catalysts Layers and Final Calcination.

Steps 3-5 (of dip-coating-drying-calcination) are repeated several times (normally 1-30 times) to achieve desired catalysts loading. Final calcination is applied for 1 hour.
All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application.
The terms and expressions which have been employed herein are used as terms of description and not of limitation, and there is no intention in the use of such terms and expressions of excluding any equivalents of the features shown and described or portions thereof, but it is recognized that various modifications are possible within the scope of the presently disclosed subject matter claimed. Thus, it should be understood that although the presently disclosed subject matter has been specifically disclosed by preferred embodiments, exemplary embodiments and optional features, modification and variation of the concepts herein disclosed may be resorted to by those skilled in the art, and that such modifications and variations are considered to be within the scope of this presently disclosed subject matter as defined by the appended claims.
The specific embodiments provided herein are examples of useful embodiments of the presently disclosed subject matter and it will be apparent to one skilled in the art that the presently disclosed subject matter may be carried out using a large number of variations of the devices, device components, and method steps set forth in the present description. As will be obvious to one of skill in the art, methods and devices useful for the present methods can include a large number of optional composition and processing elements and steps.
When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and sub-combinations possible of the group are intended to be individually included in the disclosure. When a compound is described herein such that a particular isomer, enantiomer or diastereomer of the compound is not specified, for example, in a formula or in a chemical name, that description is intended to include each isomer and enantiomer of the compound described individually or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.
   It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”
Unless defined otherwise, all technical and scientific terms used herein have the same meanings as commonly understood by one of ordinary skill in the art to which this presently disclosed subject matter belongs. Although any methods and materials similar or equivalent to those described herein can be used in the practice or testing of the presently disclosed subject matter, the preferred methods and materials are described. Nothing herein is to be construed as an admission that the presently disclosed subject matter is not entitled to antedate such disclosure by virtue of prior presently disclosed subject matter.
Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein. The term “about” refers to any value being lower or greater than 20% of the defined measure.
   As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The presently disclosed subject matter illustratively described herein suitably can be practiced in the absence of any element or elements, limitation or limitations which is not specifically disclosed herein.
One of ordinary skill in the art will appreciate that starting materials, biological materials, reagents, synthetic methods, purification methods, analytical methods, assay methods, and biological methods other than those specifically exemplified can be employed in the practice of the presently disclosed subject matter without resort to undue experimentation. All art-known functional equivalents, of any such materials and methods are intended to be included in this presently disclosed subject matter. The terms and expressions which have been employed are used as terms of description and not of limitation, and there is no intention in the use of such terms and expressions of excluding any equivalents of the features shown and described or portions thereof, but it is recognized that various modifications are possible within the scope of the presently disclosed subject matter claimed. Thus, it should be understood that although the presently disclosed subject matter has been specifically disclosed by preferred embodiments and optional features, modification and variation of the concepts herein disclosed can be resorted to by those skilled in the art, and that such modifications and variations are considered to be within the scope of this presently disclosed subject matter as defined by the appended claims.

1. A membrane element configured for filtration of water while simultaneously co-generating hydrogen, the membrane element comprises at least one anode electrode and at least one cathode electrode, each is in communication with at least one membrane; said at least one membrane is adapted for electrolysis of at least a portion of said water to simultaneously at least partially generate hydrogen therefrom; wherein at least one electrode selected from a group consisting of at least one anode electrode, at least one cathode electrode and any combination thereof is at least partially coated with at least one catalyst.

2. The membrane element according to claim 1, wherein said at least one catalyst is selected from a group consisting of Cobalt, Cerium, Cerium oxide, Cobalt oxide, Co₃O₄, CoO, Co₂O₃, and any combination thereof.

3. The membrane element according to claim 1, wherein said is at least partially coating at least one electrode selected from a group consisting of at least one anode electrode, at least one cathode electrode and any combination thereof comprising at least one selected from a group consisting of:
a. at least partially etching at least one electrode selected from a group consisting of at least one anode electrode, at least one cathode electrode and any combination thereof;
b. at least partially dip-coating of at least one electrode selected from a group consisting of at least one anode electrode, at least one cathode electrode and any combination thereof within precursor solution;
c. at least partially applying said precursor solution onto the surface of at least one electrode selected from a group consisting of at least one anode electrode, at least one cathode electrode and any combination thereof by means selected from a group consisting of brushing, spraying and any combination thereof;
d. at least partially drying said at least one electrode selected from a group consisting of at least one anode electrode, at least one cathode electrode and any combination thereof with a Co-precursor solution coated thereon;
e. at least partially calcinating said at least one electrode selected from a group consisting of at least one anode electrode, at least one cathode electrode and any combination thereof with a Co-precursor solution coated thereon;
f. any combination thereof.

4. The membrane element according to claim 3, wherein said etching is selected from a group consisting of chemical etching, sandblasting and any combination thereof.

5. The membrane element according to claim 3, wherein said precursor solution is selected from a group consisting of Cobalt nitrate hexahydrate, Cobalt Nitrate, Cobalt acetate and any combination thereof.

6. The membrane element according to claim 3, wherein said at least partially dip-coating is performed by at least partially vertically inserting said at least one electrode selected from a group consisting of at least one anode electrode, at least one cathode electrode and any combination thereof into and out of the precursor solution.

7. The membrane element according to claim 1, wherein said at least one electrode selected from a group consisting of at least one anode electrode, at least one cathode electrode and any combination thereof at least partially comprises a predetermined pattern.

8. The membrane element according to claim 1, wherein at least electrode selected from a group consisting of at least one anode electrode, at least one cathode electrode and any combination thereof also functions as at least one spacer selected from a group consisting of permeate spacer, feed spacer and any combination thereof.

9. The membrane element according to claim 1, wherein said membrane element further comprising at least two spacers, each separating between at least two adjacent membranes; wherein said at least two spacers are at least partially in mechanical communication therebetween.

10. The membrane element according to claim 1, wherein said spacer is at least one selected from a group permeate spacer, feed spacer and any combination thereof.

11. The membrane element according to claim 1, wherein said mechanical communication is at least partially coupling said at least two spacers; said coupling is selected from a group consisting of welding, gluing and any combination thereof.

12. The membrane element according to claim 1, wherein said membrane element additionally comprising at least one bi-polar electrode disposed between the at least one anode electrode and the at least one cathode electrode.

13. The membrane element according to claim 1, wherein said predetermined pattern is at least partially corrugated in at least one direction.

14. The membrane element according to claim 1, wherein at least one electrode selected from a group consisting of at least one anode electrode, at least one cathode electrode and any combination thereof functions as at least one spacer selected from a group consisting of permeate spacer, feed spacer and any combination thereof.

15. The membrane element according to claim 1, wherein said membrane configured for filtration of water when a pressure difference is provided across said membrane.

16. The membrane element according to claim 1, wherein said membrane is configured for osmotic and/or gauge pressure driven filtration of water.

17. The membrane element according to claim 1, wherein said membrane is selectively permeable membrane configured to at least partially purify feed water when a pressure difference is provided across said membrane.

18. The membrane element according to claim 1, wherein at least one selected from a group consisting of said at least one anode electrode, said at least one cathode electrode and any combination thereof is made of at least one material selected from titanium, carbon fiber, carbon cloth, graphene and any combination thereof.

19. The membrane element according to claim 1, wherein at least one selected from a group consisting of said at least one anode electrode, said at least one cathode electrode and any combination thereof is at least partially coated or at least partially cladded with at least one catalyst.

20. The membrane element according to claim 19, wherein said catalyst is selected from a group consisting of iridium oxide, ruthenium oxide, tantalum oxide, titanium oxide, platinum, and platinum oxide, Cobalt, Cobalt oxide, Nickel, Nickel oxide and any combination thereof.

21. The membrane element according to claim 1, wherein at least one selected from a group consisting of said at least one anode electrode, said at least one cathode electrode and any combination thereof is provided in the form of at least one selected from a group consisting of mesh, foil, plate, cloth, fiber, sintered body and any combination thereof.

22. The membrane element according to claim 1, wherein the membrane element includes at least one selected from a group consisting of feed spacers, permeate spacers and any combination thereof; and the at least one anode electrode and/or the at least one cathode electrode are provided by the feed or permeate spacer or are provided on or adjacent one or other of the feed and/or permeate spacers or are coupled to at least one selected from a group consisting of feed spacers, permeate spacers or are at least partially coated or at least partially cladded on at least one selected from a group consisting of feed spacers, permeate spacers and any combination thereof.

23. The membrane element according to claim 1, wherein at least one electrode is formed from graphene.

24. The membrane element according to claim 1, wherein at least one electrode is provided in the form of a grid or parallel spaced apart strips.

25. The membrane element according to claim 23, wherein at least one electrode is in the form of a full or partial coating or a full or partial cladding of the permeate and/or feed spacer.

26. The membrane element according to claim 25, wherein a catalyst is provided on one or both of the anode electrode and the cathode electrode.

27. The membrane element according to claim 1, further comprising collecting means for collecting the dissolved hydrogen and/or free gas hydrogen in the product water or optional reject flow for subsequent extraction by degasification or gas membrane separation.

28. The membrane element according to claim 1, wherein at least one of the following is held true (a) the water filtration process is selected from the group consisting of reverse osmosis, pressure retarded osmosis (PRO), forward osmosis (FO), ultrafiltration, microfiltration and nanofiltration; (b) said water is selected from a group consisting of sea water, brackish water, wastewater, fresh water and any combination thereof; (c) any combination thereof.

29. The membrane element according to claim 1, wherein a low current density below 100 mA/cm² is applied across the electrodes to enable electrochemical splitting of the water to occur, preferably being below 10 mA/cm²; especially below 5 mA/cm², ideally below 1 mA/cm².

30. A method of generating hydrogen during pressure driven water desalination process, comprising steps of:
a. supplying feed water to at least one membrane, comprising at least one anode electrode and at least one cathode electrode, in communication with said membrane, according to claim 1;
b. filtering said water; while simultaneously co-generating hydrogen;
wherein said step of co-generating hydrogen comprising step of applying either a potential difference or current between said at least one anode electrode and said at least one cathode electrode; thereby generating by electrolysis hydrogen and oxygen from at least a portion of at least one selected from a group consisting of the feed, product water and any combination thereof.

31. The method according to claim 30, wherein said step of filtering said water additionally comprising step of applying a pressure differential across said membrane to draw feed water through said membrane to form a product water.

32. The method according to claim 30, wherein at least one selected from a group consisting of said at least one anode electrode, said at least one cathode electrode and any combination thereof is made of at least one material selected from titanium, carbon fiber, carbon cloth, graphene, and any combination thereof.

33. The method according to claim 30, wherein at least one selected from a group consisting of said at least one anode electrode, said at least one cathode electrode and any combination thereof is at least partially coated or at least partially cladded with at least one catalyst.

34. The method according to claim 30, wherein said catalyst is selected from a group consisting of iridium oxide, ruthenium oxide, tantalum oxide, titanium oxide, platinum, and platinum oxide, Cobalt, Cobalt oxide, Nickel, Nickel oxide and any combination thereof.

35. The method according to claim 30, wherein at least one selected from a group consisting of said at least one anode electrode, said at least one cathode electrode and any combination thereof is provided in the form of at least one selected from a group consisting of mesh, foil, plate, cloth, fiber, sintered body and any combination thereof.

36. The method according to claim 30, further comprising collecting the dissolved hydrogen and/or free gas hydrogen in the product water or optional reject flow for subsequent extraction by degasification or gas membrane separation.

37. The method according to claim 30, wherein the water filtration process is selected from the group consisting of reverse osmosis, pressure retarded osmosis (PRO), forward osmosis (FO), ultrafiltration, microfiltration and nanofiltration.

38. The method according to claim 30, wherein a low current density below 100 mA/cm² is applied across the electrodes to enable electrochemical splitting of the water to occur, preferably being below 10 mA/cm²; especially below 5 mA/cm², ideally below 1 mA/cm².

39. The method according to claim 30, wherein said water is selected from a group consisting of sea water, brackish water, wastewater, fresh water and any combination thereof.

40. A water filtration module configured for pressure driven filtration of water and simultaneous electrochemical splitting of at least a proportion of the water for the co-generation of hydrogen, the module comprising:
a feed water inlet;
at least one membrane element as claimed in claim 1;
a product water outlet; and
optionally a reject water outlet.

41. The module according to claim 40, wherein the membrane comprises a salt rejection layer and a support layer, the at least one anode electrode and/or at least one cathode electrode comprising the salt rejection layer and/or being provided in, on or between one or both the salt rejection and support layers.

42. The module according to claim 40, wherein at least one electrode is in the form of a full or partial coating or a full or partial cladding of the permeate and/or feed spacer.

43. The module according to claim 40, wherein a catalyst is provided on one or both of the anode electrode and the cathode electrode.

44. The module according to claim 40, further comprising collecting means for collecting the dissolved hydrogen and/or free gas hydrogen in the product water or optional reject flow for subsequent extraction by degasification or gas membrane separation.

45. The module according to claim 40, wherein the water filtration process is selected from the group consisting of reverse osmosis, pressure retarded osmosis (PRO), forward osmosis (FO), ultrafiltration, microfiltration and nanofiltration.

46. The module according to claim 40, wherein a low current density below 100 mA/cm² is applied across the electrodes to enable electrochemical splitting of the water to occur, preferably being below 10 mA/cm²; especially below 5 mA/cm², ideally below 1 mA/cm².

47. A system for pressure-driven water purification with the simultaneous co-generation of hydrogen, the system comprising:
a feed water inlet;
at least one membrane element according to any one of claim 1;
at least one pump to apply a pressure to the feed water;
a power source to provide a potential difference to the electrodes of the membrane element;
a product water outlet; and optionally a reject flow outlet; and,
a hydrogen outlet within the product and/or reject flow.

48. A process for pressure driven water purification with simultaneous co-generation of hydrogen, the process comprising:
supplying feed water from a feed water inlet to a membrane element according to claim 1;
applying a pressure differential across the selectively permeable membrane of the membrane element to draw feed water through the membrane to form a product water and optionally a reject flow;
applying a potential difference between the electrodes of the membrane element to cause simultaneous electrochemical splitting of at least a portion of at least one of the feed and/or product water to form hydrogen and oxygen; and
collecting the product water and optionally a reject flow, and hydrogen.

49. The process according to claim 48, further comprising collecting dissolved hydrogen and/or free gas hydrogen in the product water or optional reject flow for subsequent extraction by degasification or gas membrane separation.

50. The process according to claim 48, wherein the pressure driven water filtration process is selected from the group consisting of reverse osmosis, pressure retarded osmosis (PRO), forward osmosis (FO), ultrafiltration, microfiltration and nanofiltration.

51. The process according to claim 48, wherein a low current density below 100 mA/cm² is applied across the electrodes to enable electrochemical splitting of the water to occur, preferably being below 10 mA/cm²; especially below 5 mA/cm², ideally below 1 mA/cm².

52. The process according to claim 48, further comprising delivering feed and draw solutions of different osmotic and gauge pressures to opposing sides of the selectively permeable membrane element; applying a current across the electrodes of the membrane to split the low salinity solution into hydrogen and oxygen; and collecting the hydrogen and oxygen.
